(19) United States
(12) Patent Application Publication
(10) Pub. No.: US 2025/0086839 A1
(43) Pub. Date: Mar. 13, 2025

(54) PHYSICAL LEVEL IMAGE COMPRESSION AND TRANSMISSION

(71) Applicant: QUALCOMM Incorporated, San Diego, CA (US)

(72) Inventors: David YUNUSOV, Holon (IL); Shay LANDIS, Hod Hasharon (IL); Assaf TOUBOUL, Netanya (IL)

(21) Appl. No.: 18/466,340

(22) Filed: Sep. 13, 2023

(51) Int. Cl. G06T 9/00; G06T 5/00; G06T 7/10

(52) U.S. Cl. CPC G06T 9/00; G06T 5/77; G06T 7/10

(57) ABSTRACT

Methods, systems, and devices for wireless communications are described. A user equipment (UE) may transmit an indication of one or more masking parameters associated with an inpainting scheme to a receiving device. The UE may remove, according to the one or more masking parameters of the inpainting scheme, a portion of image data from an image to obtain a masked image, the masked image having a smaller amount of image data than the image. The UE may compress, according to a compression scheme, the masked image to obtain a compressed image, the compressed image having a smaller amount of image data than the masked image based at least in part on the compression. The UE may transmit the compressed image to the receiving device.

### FIELD OF TECHNOLOGY

The following relates to wireless communications, including physical level image compression and transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support physical level image compression (e.g., image compression and signaling at a physical layer of a wireless communications protocol). For example, the described techniques provide for improved image transmission efficiency. Broadly, this may include image compression and additional techniques to further reduce the amount of image data being conveyed per-image and/or per-set of images (e.g., video). For example, a user equipment (UE) (e.g., an extended reality (XR) device) may transmit or otherwise provide an indication of masking parameter(s) to a receiving device (e.g., another UE connected with the XR device and/or a network entity). The masking parameter(s) may generally be for an inpainting scheme. The inpainting scheme may generally define a process where a portion of the image data is removed and then reconstructed using, for example, a generally adversarial network (GAN) employed by the receiving device.

Accordingly, the UE (e.g., the XR device) may remove a portion of the image data (e.g., mask the image) according to the masking parameter(s) and then compress the masked image. The compression scheme may generally further remove the amount of image data (e.g., relative to the masked image). The UE (e.g., the XR device) may transmit or otherwise provide the compressed image (e.g., the masked image that was then compressed) to the receiving device. The receiving device may decompress the compressed image to recover the masked image and then reconstruct the image from the masked image according to the inpainting scheme. For example, the receiving device may use the masking parameter(s) in the inpainting scheme to reconstruct the masked portion of the image (e.g., corresponding to the portion of the image data that was removed by the XR device) that recreates the original image when combined with the masked image.

A method for wireless communications by a UE is described. The method may include transmitting an indication of one or more masking parameters associated with an inpainting scheme to a receiving device, removing, according to the one or more masking parameters of the inpainting scheme, a portion of image data from an image to obtain a masked image, the masked image having a smaller amount of image data than the image, compressing, according to a compression scheme, the masked image to obtain a compressed image, the compressed image having a smaller amount of image data than the masked image based on the compression, and transmitting the compressed image to the receiving device.

A UE for wireless communications is described. The UE may include one or more memories storing processor executable code, and one or more processors coupled with the one or more memories. The one or more processors may individually or collectively operable to execute the code to cause the UE to transmit an indication of one or more masking parameters associated with an inpainting scheme to a receiving device, remove, according to the one or more masking parameters of the inpainting scheme, a portion of image data from an image to obtain a masked image, the masked image having a smaller amount of image data than the image, compress, according to a compression scheme, the masked image to obtain a compressed image, the compressed image having a smaller amount of image data than the masked image based on the compression, and transmit the compressed image to the receiving device.

Another UE for wireless communications is described. The UE may include means for transmitting an indication of one or more masking parameters associated with an inpainting scheme to a receiving device, means for removing, according to the one or more masking parameters of the inpainting scheme, a portion of image data from an image to obtain a masked image, the masked image having a smaller amount of image data than the image, means for compressing, according to a compression scheme, the masked image to obtain a compressed image, the compressed image having a smaller amount of image data than the masked image based on the compression, and means for transmitting the compressed image to the receiving device.

A non-transitory computer-readable medium storing code for wireless communications is described. The code may include instructions executable by a processor to transmit an indication of one or more masking parameters associated with an inpainting scheme to a receiving device, remove, according to the one or more masking parameters of the inpainting scheme, a portion of image data from an image to obtain a masked image, the masked image having a smaller amount of image data than the image, compress, according to a compression scheme, the masked image to obtain a compressed image, the compressed image having a smaller amount of image data than the masked image based on the compression, and transmit the compressed image to the receiving device.

Some examples of the method, user equipment (UEs), and non-transitory computer-readable medium described herein may further include operations, features, means, or instructions for transmitting an activation message initiating the inpainting scheme for the image to the receiving device, where the removing may be based on the activation message.

Some examples of the method, UEs, and non-transitory computer-readable medium described herein may further include operations, features, means, or instructions for receiving an activation message from the receiving device initiating the inpainting scheme for the image, where the removing may be based on the activation message.

Some examples of the method, UEs, and non-transitory computer-readable medium described herein may further include operations, features, means, or instructions for transmitting an image masking capability of the UE to the receiving device, where the inpainting scheme may be based on the image masking capability.

Some examples of the method, UEs, and non-transitory computer-readable medium described herein may further include operations, features, means, or instructions for communicating with the receiving device to train the inpainting scheme to recover the image from the compressed image, the inpainting scheme based on the training.

Some examples of the method, UEs, and non-transitory computer-readable medium described herein may further include operations, features, means, or instructions for receiving a signal from the receiving device indicating one or more updated model parameters for the inpainting scheme, where the training may be based on the one or more updated model parameters.

In some examples of the method, UEs, and non-transitory computer-readable medium described herein, the one or more updated model parameters include at least one of one or more updated model weighting factors to be applied for the inpainting scheme, a subset of layers of the inpainting scheme to be trained during the training, an updated loss function to be applied for the inpainting scheme, one or more sensors associated with the training, or a combination thereof.

Some examples of the method, UEs, and non-transitory computer-readable medium described herein may further include operations, features, means, or instructions for transmitting an updated model weighting factor to be applied for the inpainting scheme, where removing the portion of the image data may be based on the updated model weighting factor.

Some examples of the method, UEs, and non-transitory computer-readable medium described herein may further include operations, features, means, or instructions for receiving an updated model weighting factor to be applied for the inpainting scheme, where removing the portion of the image data may be based on the updated model weighting factor.

Some examples of the method, UEs, and non-transitory computer-readable medium described herein may further include operations, features, means, or instructions for receiving a set of available inpainting schemes associated with the receiving device and transmitting a selected inpainting scheme from the set of available inpainting schemes to the receiving device, where the inpainting scheme includes the selected inpainting scheme.

Some examples of the method, UEs, and non-transitory computer-readable medium described herein may further include operations, features, means, or instructions for transmitting a preferred inpainting scheme to be applied to the masked image to the receiving device, where the inpainting scheme may be based on the preferred inpainting scheme.

Some examples of the method, UEs, and non-transitory computer-readable medium described herein may further include operations, features, means, or instructions for receiving a preferred inpainting scheme to be applied to the masked image from the receiving device, where the inpainting scheme may be based on the preferred inpainting scheme.

In some examples of the method, UEs, and non-transitory computer-readable medium described herein, the portion of the image data may be removed from the image or from a field-of-view region of the image, the field-of-view region based on one or more sensors associated with the UE.

In some examples of the method, UEs, and non-transitory computer-readable medium described herein, the one or more masking parameters include at least one of a masking region of the image, a masking shape, a masking size, a masking location within the image, a masking periodicity, a masking index from a set of masking indices associated with the UE, or a combination thereof.

Some examples of the method, UEs, and non-transitory computer-readable medium described herein may further include operations, features, means, or instructions for removing the portion of image data includes at least one of removing a masked portion of the image, removing a set of masked portions from each image in a corresponding set of images, removing a frame image from a video, or a combination thereof.

In some examples of the method, UEs, and non-transitory computer-readable medium described herein, the compressed image is transmitted via a physical layer channel associated with a Uu interface, a PC5 interface, or both.

A method for wireless communications by a receiving device is described. The method may include receiving an indication of one or more masking parameters for an inpainting scheme for a UE, receiving a compressed image from the UE, decompressing, according to a compression scheme, the compressed image to obtain a masked image, and reconstructing, according to the one or more masking parameters for the inpainting scheme, an image from the masked image, the inpainting scheme generating a mask portion of the masked image that recreates the image when combined with the masked image.

A receiving device for wireless communications is described. The receiving device may include one or more memories storing processor executable code, and one or more processors coupled with the one or more memories. The one or more processors may individually or collectively operable to execute the code to cause the receiving device to receive an indication of one or more masking parameters for an inpainting scheme for a UE, receive a compressed image from the UE, decompress, according to a compression scheme, the compressed image to obtain a masked image, and reconstruct, according to the one or more masking parameters for the inpainting scheme, an image from the masked image, the inpainting scheme generating a mask portion of the masked image that recreates the image when combined with the masked image.

Another receiving device for wireless communications is described. The receiving device may include means for receiving an indication of one or more masking parameters for an inpainting scheme for a UE, means for receiving a compressed image from the UE, means for decompressing, according to a compression scheme, the compressed image to obtain a masked image, and means for reconstructing, according to the one or more masking parameters for the inpainting scheme, an image from the masked image, the inpainting scheme generating a mask portion of the masked image that recreates the image when combined with the masked image.

A non-transitory computer-readable medium storing code for wireless communications is described. The code may include instructions executable by a processor to receive an indication of one or more masking parameters for an inpainting scheme for a UE, receive a compressed image from the UE, decompress, according to a compression scheme, the compressed image to obtain a masked image, and reconstruct, according to the one or more masking parameters for the inpainting scheme, an image from the masked image, the inpainting scheme generating a mask portion of the masked image that recreates the image when combined with the masked image.

Some examples of the method, receiving devices, and non-transitory computer-readable medium described herein may further include operations, features, means, or instructions for receiving from the UE an activation message initiating the inpainting scheme for the image, where the reconstructing may be based on the activation message.

Some examples of the method, receiving devices, and non-transitory computer-readable medium described herein may further include operations, features, means, or instructions for transmitting to the UE an activation message initiating the inpainting scheme for the image, where the reconstructing may be based on the activation message.

Some examples of the method, receiving devices, and non-transitory computer-readable medium described herein may further include operations, features, means, or instructions for receiving an image masking capability of the UE, where the inpainting scheme may be based on the image masking capability.

Some examples of the method, receiving devices, and non-transitory computer-readable medium described herein may further include operations, features, means, or instructions for communicating with the UE to train the inpainting scheme to reconstruct the image from the masked image, the inpainting scheme based on the training.

Some examples of the method, receiving devices, and non-transitory computer-readable medium described herein may further include operations, features, means, or instructions for transmitting a signal to the UE indicating one or more updated model parameters for the inpainting scheme, where the training may be based on the one or more updated model parameters.

In some examples of the method, receiving devices, and non-transitory computer-readable medium described herein, the one or more updated model parameters include at least one of one or more updated model weighting factors to be applied for the inpainting scheme, a subset of layers of the inpainting scheme to be trained during the training, an updated loss function to be applied for the inpainting scheme, one or more sensors associated with the training, or a combination thereof.

Some examples of the method, receiving devices, and non-transitory computer-readable medium described herein may further include operations, features, means, or instructions for receiving an updated model weighting factor to be applied for the inpainting scheme, where reconstructing the image may be based on the updated model weighting factor.

Some examples of the method, receiving devices, and non-transitory computer-readable medium described herein may further include operations, features, means, or instructions for transmitting an updated model weighting factor to be applied for the inpainting scheme, where reconstructing the image may be based on the updated model weighting factor.

Some examples of the method, receiving devices, and non-transitory computer-readable medium described herein may further include operations, features, means, or instructions for transmitting a set of available inpainting schemes associated with the receiving device to the UE and receiving a selected inpainting scheme from the set of available inpainting schemes to the receiving device, where the inpainting scheme includes the selected inpainting scheme.

Some examples of the method, receiving devices, and non-transitory computer-readable medium described herein may further include operations, features, means, or instructions for receiving a preferred inpainting scheme to be applied to the masked image from the UE, where the inpainting scheme may be based on the preferred inpainting scheme.

Some examples of the method, receiving devices, and non-transitory computer-readable medium described herein may further include operations, features, means, or instructions for transmitting a preferred inpainting scheme to be applied to the masked image to the UE, where the inpainting scheme may be based on the preferred inpainting scheme.

In some examples of the method, receiving devices, and non-transitory computer-readable medium described herein, the one or more masking parameters include at least one of a masking region of the image, a masking shape, a masking size, a masking location within the image, a masking periodicity, a masking index from a set of masking indices associated with the UE, or a combination thereof.

Some examples of the method, receiving devices, and non-transitory computer-readable medium described herein may further include operations, features, means, or instructions for reconstructing the image includes at least one of reconstructing a masked portion of the image, reconstructing a set of masked portions from each image in a corresponding set of images, reconstructing a frame image from a video, or a combination thereof.

In some examples of the method, UEs, and non-transitory computer-readable medium described herein, the compressed image is received via a physical layer channel associated with a Uu interface, a PC5 interface, or both.

### BRIEF DESCRIPTION OF THE DRAWINGS

FIG. 1 shows an example of a wireless communications system that supports physical level image compression and transmission in accordance with one or more aspects of the present disclosure.

FIG. 2 shows an example of a wireless communications system that supports physical level image compression and transmission in accordance with one or more aspects of the present disclosure.

FIG. 3 shows an example of a wireless communications system that supports physical level image compression and transmission in accordance with one or more aspects of the present disclosure.

FIG. 4 shows an example of a generally adversarial network (GAN) that supports physical level image compression and transmission in accordance with one or more aspects of the present disclosure.

FIG. 5 shows an example of a process that supports physical level image compression and transmission in accordance with one or more aspects of the present disclosure.

FIGS. 6 and 7 show block diagrams of devices that support physical level image compression and transmission in accordance with one or more aspects of the present disclosure.

FIG. 8 shows a block diagram of a communications manager that supports physical level image compression and transmission in accordance with one or more aspects of the present disclosure.

FIG. 9 shows a diagram of a system including a device that supports physical level image compression and transmission in accordance with one or more aspects of the present disclosure.

FIGS. 10 and 11 show block diagrams of devices that support physical level image compression and transmission in accordance with one or more aspects of the present disclosure.

FIG. 12 shows a block diagram of a communications manager that supports physical level image compression and transmission in accordance with one or more aspects of the present disclosure.

FIG. 13 shows a diagram of a system including a device that supports physical level image compression and transmission in accordance with one or more aspects of the present disclosure.

FIGS. 14 through 18 show flowcharts illustrating methods that support physical level image compression and transmission in accordance with one or more aspects of the present disclosure.

### DETAILED DESCRIPTION

Advanced wireless networks may include extended reality (XR) devices worn or otherwise carried by users (e.g., in addition to a user equipment (UE)). The XR devices include various cameras and sensors designed to dynamically augment the environment of the user with additional information. Processing and communication loads for such XR devices has resulted in some functions being offloaded from the XR device to the user's UE, or to the network. One example of this includes image processing where an image (e.g., single image or images of a video) taken by the XR device is relayed to the UE (or network) for processing (e.g., for pattern/object recognition to determine useful environmental augmentation information). However, the amount of data used to communicate the image (or video) from the XR device to the UE (or network) is extensive, resulting in image compression techniques applied to the image before transmission. After such image compression is utilized, the amount of image data—and corresponding power consumption—being conveyed continues to push or exceed network capacity. Accordingly, additional techniques to improve image transmission efficiency are needed.

The described techniques relate to improved methods, systems, devices, and apparatuses that support physical level image compression, or image compression and signaling using physical channels of a wireless communications protocol. For example, the described techniques provide for improved image transmission efficiency. Broadly, this may include image compression and additional techniques to further reduce the amount of image data being conveyed per-image and/or per-set of images (e.g., video). For example, a UE (e.g., an XR device) may transmit or otherwise provide an indication of masking parameter(s) to a receiving device (e.g., the UE of the user associated with the XR device and/or to a network entity). The masking parameter(s) may generally be for an inpainting scheme. The inpainting scheme may generally define a process by which a portion of the image data is removed and then reconstructed using, for example, a generally adversarial network (GAN) employed by the receiving device.

Accordingly, the UE (e.g., the XR device) may remove a portion of the image data (e.g., mask the image) according to the masking parameter(s) and then compress the masked image. The compression scheme may generally further remove the amount of image data (e.g., relative to the masked image). The UE (e.g., the XR device) may transmit or otherwise provide the compressed image (e.g., the masked image that was then compressed) to the receiving device. The receiving device may decompress the compressed image to recover the masked image and then reconstruct the image from the masked image according to the inpainting scheme. For example, the receiving device may use the masking parameter(s) in the inpainting scheme to reconstruct the masked portion of the image (e.g., corresponding to the portion of the image data that was removed by the XR device) that recreates the original image when combined with the masked image.

Aspects of the disclosure are initially described in the context of wireless communications systems. Aspects of the disclosure are further illustrated by and described with reference to apparatus diagrams, system diagrams, and flowcharts that relate to physical level image compression and transmission.

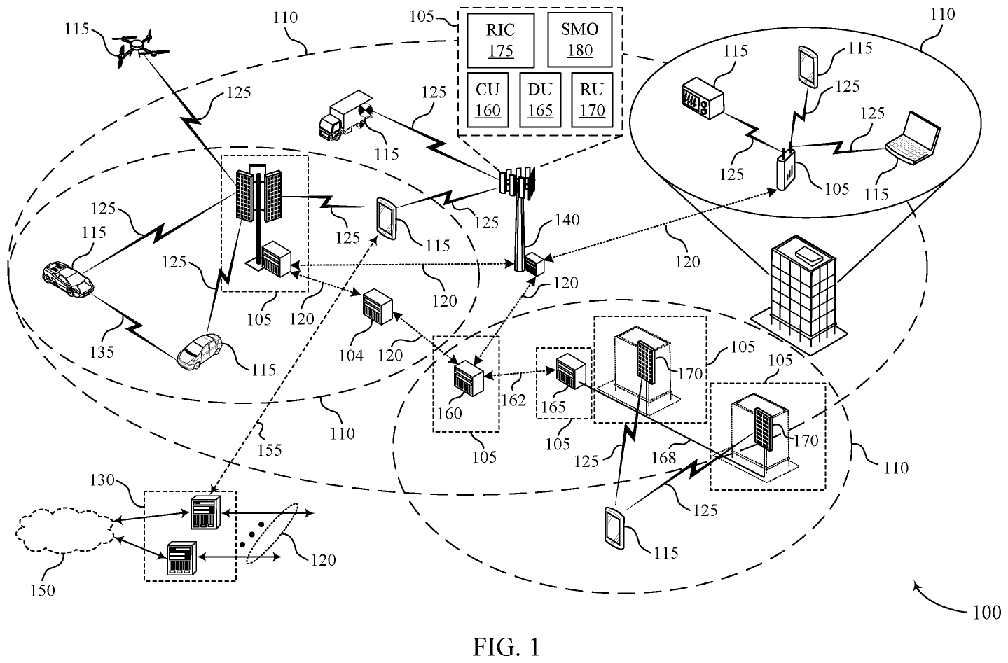

FIG. 1 shows an example of a wireless communications system 100 that supports physical level image compression and transmission in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support physical level image compression and transmission as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, an XR device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 (e.g., an XR device) may transmit an indication of one or more masking parameters associated with an inpainting scheme to a receiving device (e.g., another UE 115 and/or a network entity 105). The UE 115 may remove, according to the one or more masking parameters of the inpainting scheme, a portion of image data from an image to obtain a masked image, the masked image having a smaller amount of image data than the image. The UE 115 may compress, according to a compression scheme, the masked image to obtain a compressed image, the compressed image having a smaller amount of image data than the masked image based at least in part on the compression. The UE 115 may transmit the compressed image to the receiving device, such as a physical sidelink shared channel (PSSCH), a physical uplink shared channel (PUSCH), or another physical layer channel.

A receiving device (e.g., a UE 115 and/or a network entity 105) may receive an indication of one or more masking parameters for an inpainting scheme for a UE 115. The receiving device may receive a compressed image from the UE 115. The receiving device may decompress, according to a compression scheme, the compressed image to obtain a masked image. The receiving device may reconstruct, according to the one or more masking parameters for the inpainting scheme, an image from the masked image, the inpainting scheme generating a mask portion of the masked image that recreates the image when combined with the masked image.

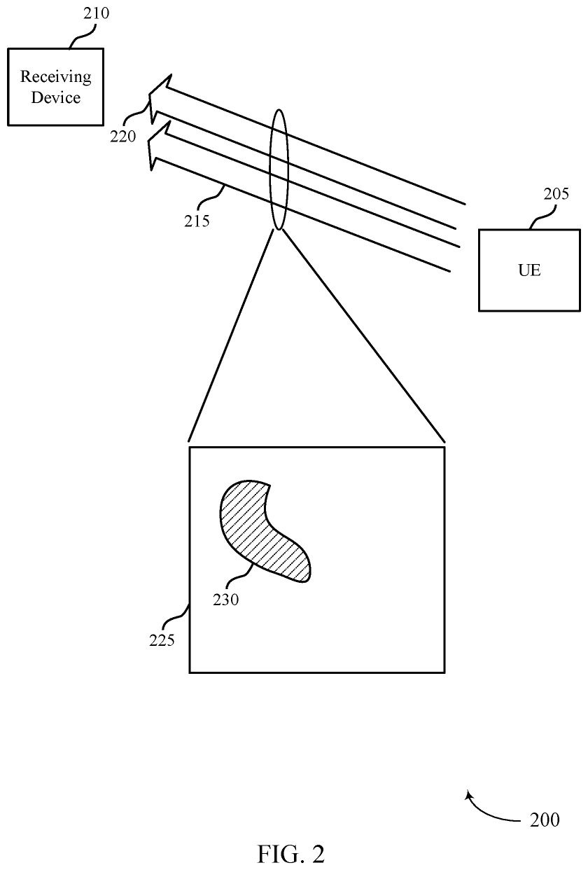

FIG. 2 shows an example of a wireless communications system 200 that supports physical level image compression and transmission in accordance with one or more aspects of the present disclosure. Wireless communications system 200 may implement aspects of wireless communications system 100. Wireless communications system 200 may include a UE 205 and/or a receiving device 210, which may be examples of the corresponding devices described herein. For example, the UE 205 may be an example of an XR device and the receiving device 210 may be an example of a UE (e.g., associated with the XR device) and/or a network entity.

XR technology (e.g., virtual reality (VR), augmented reality (AR), mixed reality (MR), or similar technologies) may be utilized by wireless communications system 200. XR technology may be adopted for applications such as gaming, healthcare, education, social, retail, and more. This may be supported by a user wearing one or more devices that collect data and images around the user, process this information, and then render additional information (e.g., overlay text, image, and more, onto the user's surroundings). Examples of XR devices may include glasses or head mounted displays (HMDs), watches, earphones, other wearable devices, or any other device capable of collecting user data and/or communicating via wireless communications system 200. In the non-limiting example illustrated in FIG. 2, the UE 205 may be considered an XR device while the receiving device 210 may be considered a UE or a network entity associated with the user.

The UE 205, the XR device in this example, may include sensor(s), such as camera(s). The camera(s) capture images (e.g., still images, videos, and/or still image(s) from a video) of the environment and/or track the eye movements of the user (e.g., to determine the user's field of view). The image(s) are then processed to identify or otherwise quantify the user's surroundings in order to render the additional information. However, such intensive processing consumes considerable power of the XR device. To mitigate the power consumption associated with XR technology, some XR devices may configure the sensors to operate in a low power mode. For example, the XR device may lower the frames-per-second (FPS) rate of captured video, reduce the resolution of the image captured by the camera(s), reduce the sampling rate of the surroundings, and more, alone or in combination.

Another technique to optimize XR device performance and efficiency is to offload the processing (and associated power consumption) load onto another device, such as the UE associated with the XR device and/or directly to the network (e.g., to the receiving device 210). In this approach, the UE 205 may compress the image(s) before transmission to the receiving device 210. For example, the XR device (e.g., the UE 205) may compress the output of the camera(s) using a compression scheme (e.g., H264, H265, or other compression schemes) to reduce the payload size before transmission. Such compression schemes are adopted to provide high quality/low latency video transmission from the XR device to the receiving device 210 for processing. Additionally, techniques include the XR device communicating the image data to the receiving device 210 via a physical channel to further reduce latency and improve efficiency.

However, while such compression techniques are helpful, the amount of image data to be communicated from the XR device to the receiving device 210 continues to be significant and consumes significant resources of the wireless network, the XR device, and the receiving device 210. Thus, additional techniques to remove the amount of image data being communicated between the XR device (e.g., the UE 205) and the receiving device 210 are needed.

Accordingly, aspects of the techniques described herein include an inpainting scheme applied to the image(s) being communicated from the UE 205 to the receiving device 210. Broadly, an inpainting scheme is a conservation process where missing parts of an image (e.g., some of the image data has been removed or masked) are regenerated or otherwise reconstructed to provide a complete image. The inpainting scheme may reconstruct the original image (e.g., approximate and add the removed image data to restore the original image) based on the surroundings and features of the missing parts. The inpainting scheme may be implemented using machine learning algorithms, such as a generative adversarial network (GAN). However, it is to be understood that other models may be used for the inpainting scheme. Accordingly, aspects of the techniques described herein further enhance image compression based on the transmitting device (e.g., the XR device, which is the UE 205 in this example) compressing and removing part(s) of the image features and the receiving device 210 decompressing and reconstructing the missing parts according to the inpainting scheme.

The inpainting scheme may be based on various masking parameter(s). The masking parameters may define various aspects of the portion of the image data that are removed before transmission to the receiving device 210. That is, the image(s) are generally represented by image data that is communicated from the UE 205 to the receiving device 210. The UE 205 may, according to the masking parameters, remove a masked portion of the image, remove a set of masked portions from each image within a set or group of images, and/or remove frame image(s) from a video. In some examples, the masking parameter(s) may identify the region or area within the image that was removed. The masking parameter(s) may be applied to the image itself or within a field-of-view region of the image (e.g., the user's field-of-view). Removing the portion of the image data reduces the amount of image data of the image. That is, applying the masking parameters (e.g., removing the portion of the image data) to the image may reduce the total amount of image data communicated from the UE 205 to the receiving device 210.

Accordingly, at 215 the UE 205 may transmit or otherwise provide (and the receiving device 210 may receive or otherwise obtain) an indication of the masking parameter(s) associated with the inpainting scheme. For example, the UE 205 may obtain or otherwise collect an image 225 (e.g., via sensor(s), such as cameras of the XR device). The masking parameters indicated to the receiving device 210 may signal or otherwise identify information to be used in the inpainting scheme to reconstruct the original image by the receiving device 210. For example, the masking parameter(s) may include an information associated with or otherwise indicating the mask region(s), the mask shape(s), the mask size(s), the mask locations (e.g., within the image), and other related information to the receiving device 210. In some examples, the masking parameter(s) may include a mask periodicity (e.g., whether the same mask applied for consecutive frames and/or until updated).

In some examples, the masking parameter(s) may include an index or other identifying information for a mask selected out of a (pre)defined set of masks (e.g., free-form mask or different known shapes). For example, the receiving device 210 may transmit or otherwise provide (and the UE 205 may receive or otherwise obtain) a signal indicating or otherwise identifying a set of available inpainting schemes associated with the receiving device 210. The masking parameter(s) indicated at 215 may carry or otherwise convey an indication of a selected inpainting scheme the set of available inpainting schemes. The selected inpainting scheme may be associated with a known or (pre)configured set of masking parameter(s) such that indicating the selected inpainting scheme identifies the associated masking parameters. Additionally, or alternatively, the selected inpainting scheme indicated in the masking parameter(s) may identify or otherwise indicate the masking parameter(s) to be applied during the inpainting operations.

The UE 205 may remove, according to the masking parameter(s), a portion of the image data from the image to obtain a masked image. As one non-limiting example, the portion of the image removed may correspond to mask 230. For example, the UE 205 may remove (e.g., filter or otherwise delete) the image data from the image corresponding to the area identified by mask 230. The image 225, after the portion of the image data corresponding to mask 230 is removed, may be referred to as a masked image.

The UE 205 may also compress the masked image to obtain a compressed image according to a compression scheme (e.g., H264/H2655). Compressing the masked image to obtain the compressed image further reduces the amount of image data (e.g., relative to the masked image). That is, applying the mask 230 to remove the portion of the image data and then compressing the masked image provides two levels of image data reduction to the image(s) to be communicated to the receiving device 210, which further improves the efficiency of the XR techniques.

At 220, the UE 205 may transmit or otherwise provide (and the receiving device 210 may receive or otherwise obtain) the compressed image via a physical layer channel, such as a PSSCH, PUSCH, or other physical channel. The receiving device 210 may decompress the image according to the compression scheme to recover or otherwise obtain the masked image. The receiving device 210 may reconstruct the image from the masked image according to the masking parameter(s) for the inpainting scheme. For example, the receiving device 210 may use the inpainting scheme to generate the mask portion of the masked image (e.g., based on mask 230, which may correspond to the masking parameter(s)).

Accordingly, aspects of the techniques described herein utilize inpainting (or other machine learning models) techniques where image/video editing (e.g., text/object removal and reconstruction) are applied. Applying the inpainting scheme to the communicated image(s) increases the image compression factor ratio of the actual image relative to the image that is transmitted to the receiving device (e.g., from the UE 205 to the receiving device 210). The UE 205 drops or otherwise removes some part (e.g., at least a portion of) the image or video, where the portion to be removed may be used by the machine learning model (e.g., the inpainting scheme) that captures or otherwise uses correlated regions of an image or video such that the receiving device 210 is trained on the on the correlated regions. The transmitting side (e.g., the UE 205), after removing the portion of the image or video, performs compression and then transmits the compressed image to the receiving device 210. The receiving device 210 decompresses the image (e.g., at least the portions of the image that were not removed before being communicated) and then applies the inpainting scheme to reconstruct the missing parts of the image. For example, the receiving device 210 may generate a mask portion corresponding to mask 230 of the masked image to recreate or reconstruct the image (e.g., when combined with the masked image).

This may result in increasing the overall compression factor for the transmitted image (e.g., the compressed image) relative to techniques that do not apply inpainting techniques. Although the examples discussed herein generally cover an uplink example (e.g., XR device-to-UE and/or network entity), it is to be understood that the techniques may also be applicable to a downlink example (e.g., network entity and/or UE-to-XR device).

As discussed, the enhanced compression scheme (e.g., compression and inpainting) may be applied to an entire image or to a field of view within the image (e.g., to reduce transmission overhead). The masking may be applied an entire frame out of a video (e.g., effectively reducing the FPS and receive-side inpainting). To support cross-layer optimization for power consumption, latency, and improve communications, the compressed image may be transmitted from the UE 205 to the receiving device 210 via the physical layer channel.

In some aspects, the inpainting scheme (e.g., model) may be trained (e.g., between the UE 205 and the receiving device 210). For example, the UE 205 and the receiving device 210 may communicate (e.g., exchange one or more messages) to train the inpainting scheme. The training process may optimize the inpainting scheme to further improve image reconstruction by the receiving device 210. For example, the entire model (e.g., the inpainting scheme) may be trained (e.g., online or offline, beforehand or as part of the inpainting scheme application). In some examples, the model training may be trained beforehand (e.g., offline) between the UE 205 and the receiving device 210. Additionally, or alternatively, the UE 205 and the receiving device 210 may perform fine-tuning training online (e.g., while performing the inpainting scheme).

In some examples, this may include various model related signaling, which may be provided via RRC signaling, medium access control-control element (MAC-CE) signaling, or other signaling (e.g., higher layer signaling). Broadly, the model related signaling may identify, define, or otherwise be used to activate or deactivate the (or a specific) inpainting scheme, update various parameter(s) associated with the inpainting scheme, various capability signaling, and more. Model related signaling via RRC, MAC-CE, or other higher layer signaling may be different from the physical layer signaling used to carry or otherwise convey the masked and compressed image.

Physical layer signaling may be transmitted over a control channel on the physical layer. Examples of control channels on the physical layer include Physical Downlink Control Channel (PDCCH) on the downlink and Physical Uplink Control Channel (PUCCH) on the uplink in LTE or 5G (NR). Model related signaling may be encoded as Downlink Control Information (DCI) carried in PDCCH or Uplink Control Information (UCI) carried in PUCCH. The encoding may employ various channel coding schemes. Examples of channel coding schemes including Turbo Codes, Polar Codes and Low-Density Parity Check (LDPC) Codes. The length for model based signaling may vary according to the information in the signaling. Encoding by Polar Codes may be subject to the constraint of length of power of 2, but padding bits can be added to information bits for the model related signaling. Other coding schemes such as convolutional codes and block codes can be employed for lower decoding complexity. The same encoder can be used for all sizes of the model related signaling wherein techniques of rate-matching can adapt the length of the coded signaling message to fit the physical channel condition. Hybrid ARQ scheme (HARQ) can be employed to realize retransmissions of messages on the physical layer to reduce latency associated with retransmissions.

One non-limiting example of such model related signaling may be used to update the model weights. That is, various masking parameter(s) associated with the inpainting scheme may be applied on an absolute basis (e.g., according to a determined value) and/or may be applied using a weighting factor (e.g., the weighting factor may increase or decrease the relevance of the parameter within the inpainting scheme). The UE 205 and/or the receiving device 210 may update various model weighting factors of the inpainting scheme (e.g., during a training process and/or separate from the training process). For example, the UE 205 may transmit or otherwise convey (and the receiving device 210 may receive or otherwise obtain) an updated model weighting factor to be applied for the inpainting scheme. Additionally, or alternatively, the receiving device 210 may transmit or otherwise convey (and the UE 205 may receive or otherwise obtain) an updated model weighting factor to be applied during the inpainting scheme.

Additionally, or alternatively, in some examples the weighting factors may be updated during the training process. For example, updated model parameter(s) may be communicated from the UE 205 and/or from the receiving device 210 that indicates or otherwise identifies various updated model parameter(s). Examples of the updated model parameter(s) include, but are not limited to, the updated model weighting factors, a subset of the layers of the inpainting scheme to be trained, updating the loss function of the model (e.g., the GAN loss function), information identifying the sensor(s) of the UE 205 associated with the training and/or with the inpainting scheme operations, and more.

In some examples, the signaling related to the UE 205 performing online model training to update the model weighting factors may be combined with a report from the UE 205 on the updated weights. For example, the report may consist of GAN updated weights, may use sub-signaling related to only a few layers of the model for the retraining, signaling related on training the model with different loss functions, signaling related to which set of sensors/cameras the inpainting is done (in some examples this can go into or otherwise be part of a larger set of model(s) that combines spatial inpainting models).

Another example of the model related signaling may include an indication of which model (e.g., which inpainting scheme) is to be applied. For example, the UE 205 may transmit or otherwise convey (and the receiving device 210 may receive or otherwise obtain) an indication of a preferred inpainting scheme that will be applied to the masked image. Additionally, or alternatively, the receiving device 210 may transmit or otherwise provide (and the UE 205 may receive or otherwise obtain) an indication of a preferred in painting scheme that will be applied to the masked image. This may support the receiving device 210 implementing a set of models (e.g., a set of available inpainting schemes) and the UE 205 may signal or otherwise indicate which model to work on or apply. This may support the UE 205 and the receiving device 210 (pre)configuring for a specific (e.g., an achievable) compression factor in terms of complexity and latency. For example, a large model may require more complexity, but may also result in an improved compression factor and inpainting recovery (e.g., image reconstruction).

Another example of such model related signaling may be capability-based. For example, the UE 205 may transmit or otherwise provide (and the receiving device 210 may receive or otherwise obtain) information indicating or otherwise identifying an image masking capability of the UE 205. The image masking capability may include information identifying a supported and/or selected FPS, resolution reduction, and or other related information. This may support the UE 205 and the receiving device 210 skipping or otherwise changing the model feature layers of the inpainting scheme. Additionally, or alternatively, the UE 205 may choose between different types of models that is optimized for each supported capability. By way of non-limiting example, reducing the FPS but increasing spatial resolution might project on different model implementations that are best suited for temporal resolution increases to overcome the FPS reduction, or vice versa.

Another example of such model related signaling may include turning the inpainting scheme on or off. For example, the UE 205 and the receiving device 210 may exchange signaling indicating whether to perform inpainting or to apply image. For example, the UE 205 may transmit or otherwise provide (and the receiving device 210 may receive or otherwise obtain), or vice versa, an activation message initiating the inpainting scheme for the image and/or for multiple images (e.g., according to the periodicity of the inpainting scheme).

Accordingly, the UE 205 and the receiving device 210 may exchange various signaling to train, select, and/or activate/deactivate the inpainting scheme (e.g., the model) to be applied to the compressed image. For example, the receiving device 210 may reconstruct the image 225 by combining the mask portion of the masked image (e.g., the portion corresponding to mask 230) and the masked image (e.g., the original, decompressed image minus the mask portion) according to the inpainting scheme.

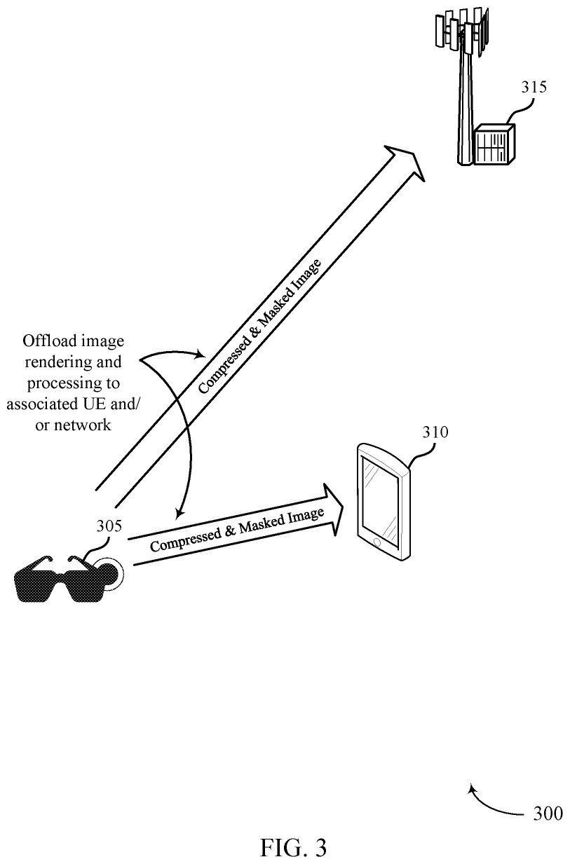

FIG. 3 shows an example of a wireless communications system 300 that supports physical level image compression and transmission in accordance with one or more aspects of the present disclosure. Wireless communications system 300 may implement aspects of wireless communications system 100 and/or wireless communications system 200. The wireless communications system 300 may include a XR device 305, a UE 310, and a network entity 315, which may be examples of the corresponding devices described herein. For example, the XR device 305 may be an example of a UE (e.g., a wearable device, such as an IoT device) and the UE 310 may be an example of a UE of the user of the XR device 305. The network entity 315 may be an example of a serving network entity or cell associated with the XR device 305 and the UE 310.

As discussed above, aspects of the techniques described herein provide for inpainting and compression of image(s) transmitted from a UE (e.g., the XR device 305, in this example) to an associated UE (e.g., the UE 310, in this example) and/or to a network entity (e.g., the network entity 315, in this example). For example, the XR device 305 may transmit an indication of masking parameter(s) associated with an inpainting scheme to a receiving device. The receiving device in this example may be the UE 310 and/or may be the network entity 315. The masking parameter(s) may generally define, at least to some degree, a portion of image data (e.g., corresponding to a portion of the image) that is masked or otherwise removed from the image to obtain a masked image. That is, the XR device 305 may capture or otherwise obtain image(s) (e.g., individual image(s), image(s) within a video, and/or a portion of image(s) corresponding to a field-of-view). The XR device 305 may remove the portion of the image according to an inpainting scheme. The XR device 305 may also compress the masked image using various compression schemes (e.g., to obtain a compressed image of the masked image). Removing the portion of the image according to the masking parameter(s) of the inpainting scheme generally reduces the amount of image data of the image. Compressing the masked image further reduces the amount of image data. Combined (e.g., inpainting and compression), the schemes result to reduce the amount of image data that is communicated to the receiving device.

The XR device 305 may transmit or otherwise provide the compressed image to the receiving device, such as over the physical layer channel. The receiving device (e.g., the UE 310 and/or the network entity 315) may decompress the compressed image (e.g., reconstruct the masked image) and then reconstruct the image from the masked image according to the inpainting scheme. The reconstructed image may be used for various XR related functions, such as analysis of the image in support of augmenting the reality of the user (e.g., via the XR device 305, which may be a set of glasses or goggles worn by the user). As discussed in more detail below, this may include the receiving device implementing a GAN to reconstruct the image according to the inpainting scheme.

Accordingly, wireless communications system 300 illustrates a non-limiting example of utilizing inpainting in combination with compression techniques for image processing in support of augmented reality and/or environmental detection and identification operations. FIG. 3 illustrates an example where the XR device 305 offloads or otherwise transfers at least part of the XR functionality (e.g., processing related to at least the image reconstruction to reduce complexity and power consumption of the XR device 305. The described techniques further improve the efficiency of such offloading operations in the context of XR functionality to the network (e.g., the network entity 315) and/or to an associated UE (e.g., the UE 310).

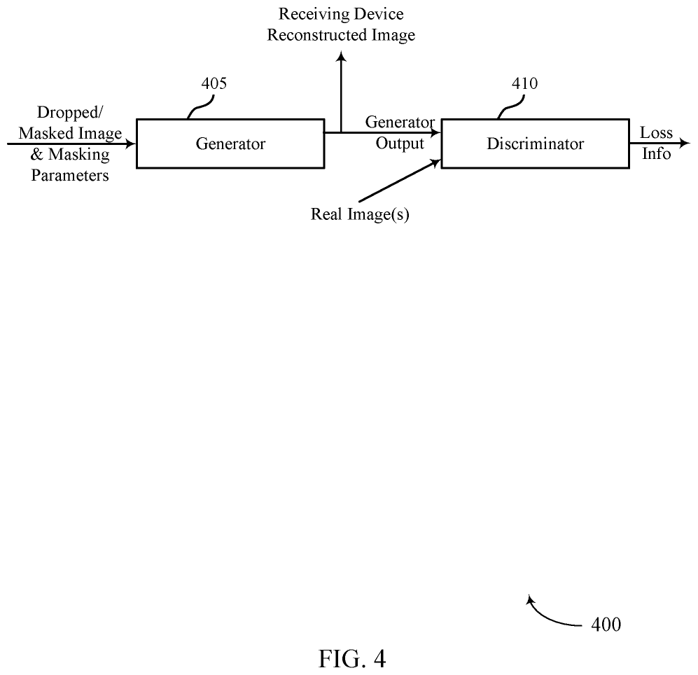

FIG. 4 shows an example of a GAN 400 that supports physical level image compression and transmission in accordance with one or more aspects of the present disclosure. Aspects of GAN 400 may implement and/or be implemented by wireless communications system 100, wireless communications system 200 and/or wireless communications system 300. Aspects of GAN 400 may be implemented at or implemented by a UE (e.g., an XR device), a UE associated the XR device, and/or a network entity, which may be examples of the corresponding devices described herein. For example, the XR device may be an example of a UE (e.g., a wearable device, such as an IoT device) and the associated UE may be an example of a UE of the user of the XR device. The network entity may be an example of a serving network entity or cell associated with the XR device and the associated UE. Broadly, the GAN 400 may include a generator 405 and/or a discriminator 410.

As discussed above, aspects of the techniques described herein provide for inpainting and compression of image(s) transmitted from the XR device to an associated UE and/or to a network entity. For example, the XR device may transmit an indication of masking parameter(s) associated with an inpainting scheme to a receiving device. The receiving device in this example may be the associated UE and/or may be the network entity. Aspects of GAN 400 may be implemented at or implemented by the associated UE and/or the network entity (e.g., implemented locally at one or both devices and/or implemented remotely in coordination with one or both devices). The masking parameter(s) may generally define, at least to some degree, a portion of image data (e.g., corresponding to a portion of the image) that is masked or otherwise removed from the image to obtain a masked image.

That is, the XR device may capture or otherwise obtain image(s) (e.g., individual image(s), image(s) within a video, and/or a portion of image(s) corresponding to a field-of-view). The XR device may remove the portion of the image according to an inpainting scheme (e.g., based on the masking parameter(s)). The XR device may also compress the masked image using various compression schemes (e.g., to obtain a compressed image of the masked image). Removing the portion of the image according to the masking parameter(s) of the inpainting scheme generally reduces the amount of image data of the image. Compressing the masked image further reduces the amount of image data. Combined (e.g., inpainting and compression), the schemes result to improve reduction of the amount of image data that is communicated to the receiving device.

The XR device may transmit or otherwise provide the compressed image to the receiving device, such as over a physical layer channel (e.g., PSSCH, PUSCH, or another physical layer channel). The receiving device may decompress the compressed image (e.g., reconstruct the masked image) and then reconstruct the image from the masked image according to the inpainting scheme. The reconstructed image may be used for various XR related functions, such as analysis of the image in support of augmenting the reality of the user (e.g., via the XR device, which may be a set of glasses or goggles worn by the user).

Although the techniques described herein are illustrated in the context of an inpainting scheme based on GAN 400, it is to be understood that these techniques are not limited to inpainting schemes and/or to utilization of a GAN. Instead, other models may be utilized to reconstruct the original image from the masked and compressed image, which may utilize a GAN architecture and/or may utilize other learning models. Accordingly, the discussion below relating to inpainting and/or GAN 400 are provided by way of non-limiting example only.

GANs, such as GAN 400, are generative models that create new instances that resemble the training dataset. The two neural nets (e.g., the generator 405 and the discriminator 410) compete, where the gain of one is the loss of the other. The core of the idea is based on “indirect” training through the discriminator 410, which tells or otherwise decides how “realistic” its input seems. The generator 405 is not trained to minimize the distance to a specific image, but rather to fool the discriminator 410. That is, the generator 405 generates new data instances (images, in this example) where the generated data (again, image in this example) becomes negative training examples for the discriminator 410. The discriminator 410 learns (e.g., is trained) to distinguish between fake data and real data output from the generator 405. For example, the discriminator 410 penalizes the generator 405 for producing implausible results.

As discussed above, aspects of the techniques described herein may include training the inpainting scheme. To some degree, this may include training the GAN 400. To train a general GAN, the generator 405 produces obviously fake data, and the discriminator 410 quickly learns to tell that it's fake (which would be a loss for the generator 405). As the training progresses, the generator 405 gets closer and closer to producing output that can fool the discriminator 410 (which would be a loss for the discriminator 410). Finally, if the generator 405 training goes well, the discriminator 410 gets worse at telling the difference between real or fake, and its accuracy decreases.

More particularly, part of the training process is for the GAN to try to replicate a probability distribution using a loss function that reflects the distance between the distribution of the generated data and the real data. A GAN can have two loss functions, one for the generator 405 training and one for the discriminator 410 training. A minimal loss function may be represented by:

$${E}_{x \sim {P}_{data} ( x )} [ log ( D ( x ) ) ] + {E}_{z \sim {P}_{z} ( z )} [ log ( 1 - D ( G ( z ) ) ) ]$$

where D(x) is the Discriminator's estimate of the probability that real data instance x is real, E_{x˜P}_{_{data}}(x) is the expected value over all real data instances, G(z) is the Generator's output when given random input z, D(G(z)) is the Discriminator's estimate of the probability that a fake instance is real, and E_{z˜P}_{_{z}}(z) is the expected value over all random inputs to the Generator (in effect, the expected value over all generated fake instances G(z)). The generator 405 cannot directly affect the log(D(x)) term in the function is for the generator 405 where minimizing the loss is equivalent to minimizing log(1−D(G(z))). In some examples, the generator 405 loss may be modified so that the generator 405 tries to maximize log (D(G(z))).

GANs may use image(s) as the data set(s) during the training process. For example, as part of a machine learning algorithmic approach the model may be trained at first on a diverse dataset of images/video frames, as well as different masks at different locations and shapes within the images/video frames. The inpainting training input may use various data for training the machine learning model. For example, the input to the generator 405 may be the image(s) (e.g., image data) of the images/video frames that are used for the model to train on a real (e.g., known) dataset. The input to the generator 405 may also include the masked data, such as the masking parameter(s). In some examples, this may include an indication of and/or information associated with the mask itself, such as the location and shape of the applied mask. In the context of inpainting schemes, the masked/removed pixels (e.g., the portion of the image data) represents the enhanced compression factor on top of the legacy compression schemes applied to the rest of the image/video. In some examples, the mask location may be unknown and therefore the network may learn or be trained on various mask shapes/locations. In some aspects of the training, the real image(s) may also be provided to the discriminator 410 in order to improve the generator 405 output. The receiving device may use the generator output as the recovered data (e.g., the reconstructed image(s), in this example).

It is to be understood that there are many inpainting models available that may be applied in accordance with the techniques described herein. In some examples, the model may use (N−1) previous image(s)/frame(s) in order to the improve the prediction of frame number N. As mentioned, the model may be trained over a large dataset of masks and input images in order to deal with any type of dropping areas (e.g., masks of different sizes, shapes, locations). For example, the output of the inpainting scheme may use the Generator output masked region (e.g., Output=Input·mask+Gen_{Out}·(1−mask). Once the training process is complete, the output image may be very similar to the original input image regarding semantic features and structural similarity. While the loss information output from the discriminator 410 may be used to determine the training results of the GAN 400, the receiving device may use the image output (e.g., the fully reconstructed image and/or the mask portion of the image) to reconstruct the original image. Accordingly, the GAN 400 may be used, at least in part, to reconstruct the image from the masked and compressed image received from the XR device.

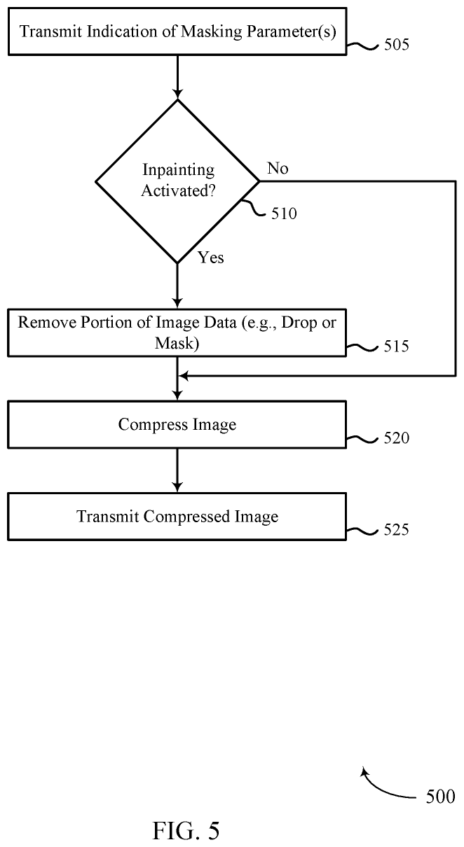

FIG. 5 shows an example of a process 500 that supports physical level image compression and transmission in accordance with one or more aspects of the present disclosure. Process 500 may implement aspects of wireless communications system 100, wireless communications system 200, wireless communications system 300, and/or aspects of GAN 400. Aspects of process 500 may be implemented at and/or implemented by a UE (e.g., an XR device), a UE (e.g., a UE associated with the XR device), and/or a network entity, which may be examples of the corresponding devices described herein.

At 505, the UE may transmit or otherwise convey an indication of and/or information identifying masking parameter(s) associated with an inpainting scheme. The indication may be provided to a receiving device. The receiving device may be associated with the UE. The receiving device may be a second UE associated with the XR device (e.g., the UE of the user using the XR device). The receiving device may be a network entity. The receiving device may be a remote service in communication with the UE(s) and/or network entity that implements aspects of the inpainting scheme.

The masking parameter(s) may carry or otherwise convey information associated with a portion of image data that has been or will be removed from an image. That is, the mask in this context refers to the portion of an image that has been removed based on removing or deleting the underlying image data for that region or mask. For example, the masking parameter(s) may indicate the size of the mask, the location of the mask, the shape of the mask, the periodicity of the mask, the image number (e.g., N) where the mask has been applied, the frames of a video that have been removed or otherwise masked, or other related information.

At 510, the UE may identify or otherwise determine whether the inpainting scheme has been activated. The inpainting scheme activation or deactivation may be based on a training status of the inpainting scheme. For example, the inpainting scheme may include or otherwise use a training process before being activated. Confirmation of the training process completion may be a threshold in determining whether the inpainting scheme can be or has been activated.

The inpainting scheme activation or deactivation may be based on whether or not the training status is current or otherwise up-to-date (e.g., the age of the most recent training process). In some examples, ongoing inpainting training may be completed to update and/or confirm the inpainting scheme is available for use.

The UE and/or the receiving device may activate or deactivate the inpainting scheme. For example, the UE may transmit an activation message to the receiving device (e.g., via RRC signaling, MAC-CE signaling, uplink control information (UCI) signaling, or using other signaling messages). The activation message may activate the inpainting scheme for the UE and the receiving device.

If the inpainting scheme is activated, at 515 the UE may remove a portion of the image data from an image (e.g., from the image data corresponding to the image). This may create a masked image where at least some of the image data has been removed, dropped, or otherwise omitted. The UE may remove the portion of the image data based, at least in part, on the masking parameter(s) indicated at 505. Removing the image data corresponding to the mask may reduce the amount of image data for the original image. For example, an original image having X image data may only have Y image data after the portion has been removed, where Y<X.

If the inpainting scheme is not activated, the UE may skip 515 (removing the portion of the image data) and instead skip to 520 where the UE compresses the image. That is and when inpainting is activated, the UE may compress the masked image (e.g., the Y image data that is remaining after the portion has been removed), which may provide a compressed image. The UE may use various compression schemes to compress the masked image. Compressing the image data corresponding to the masked image may again further reduce the amount of image data corresponding to the image. For example, the masked image having Y image data may only have Z image data after compression, where Z<Y<X.

Accordingly, at 525 the UE may transmit or otherwise convey the compressed image to a receiving device. The UE may transmit the compressed image via a physical layer channel (PSSCH, PUSCH, or another physical layer channel). In some examples, this may include transmitting “1s” and “0s” to the receiving device (e.g., rather than packing the remaining image data corresponding to the compressed image at a higher layer of the UE).

The receiving device may decompress the compressed (e.g., the portion of the image that was not removed) according to the compression scheme. The receiving device may reconstruct the image according to the masking parameter(s) and the inpainting scheme. For example, the receiving device may implement and/or be operatively coupled with a GAN (or another model) that, if trained, reconstruct the portion of the image that was removed by the UE (e.g., the mask portion). The receiving device may combine the decompressed image with the mask portion in order to reconstruct the image. The reconstructed image may be processed by the UE and/or receiving device to provide augmented information to the user (e.g., to the XR device for presentation to the user).

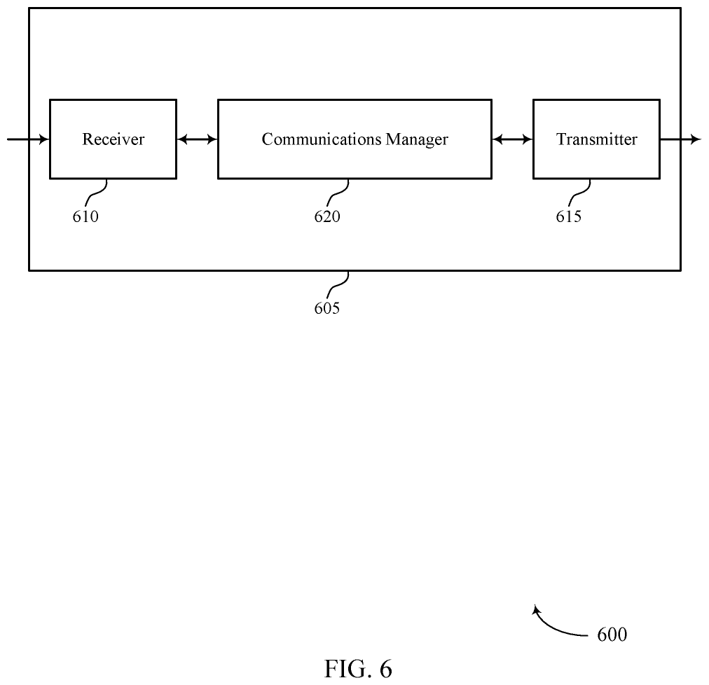

FIG. 6 shows a block diagram 600 of a device 605 that supports physical level image compression and transmission in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to physical level image compression and transmission). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to physical level image compression and transmission). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of physical level image compression and transmission as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for transmitting an indication of one or more masking parameters associated with an inpainting scheme to a receiving device. The communications manager 620 is capable of, configured to, or operable to support a means for removing, according to the one or more masking parameters of the inpainting scheme, a portion of image data from an image to obtain a masked image, the masked image having a smaller amount of image data than the image. The communications manager 620 is capable of, configured to, or operable to support a means for compressing, according to a compression scheme, the masked image to obtain a compressed image, the compressed image having a smaller amount of image data than the masked image based on the compression. The communications manager 620 is capable of, configured to, or operable to support a means for transmitting the compressed image to the receiving device.

Additionally, or alternatively, the communications manager 620 may support wireless communications in accordance with examples as disclosed herein. For example, the communications manager 620 is capable of, configured to, or operable to support a means for receiving an indication of one or more masking parameters for an inpainting scheme for a UE. The communications manager 620 is capable of, configured to, or operable to support a means for receiving a compressed image from the UE. The communications manager 620 is capable of, configured to, or operable to support a means for decompressing, according to a compression scheme, the compressed image to obtain a masked image. The communications manager 620 is capable of, configured to, or operable to support a means for reconstructing, according to the one or more masking parameters for the inpainting scheme, an image from the masked image, the inpainting scheme generating a mask portion of the masked image that recreates the image when combined with the masked image.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for providing an enhanced compression factor for image transmission by combining inpainting (removing part of the image) and compression (compressing the remaining part of the image) before transmission. The receiving device may decompress the compressed image and reconstruct the removed part using various machine learning models, such as the inpainting scheme.

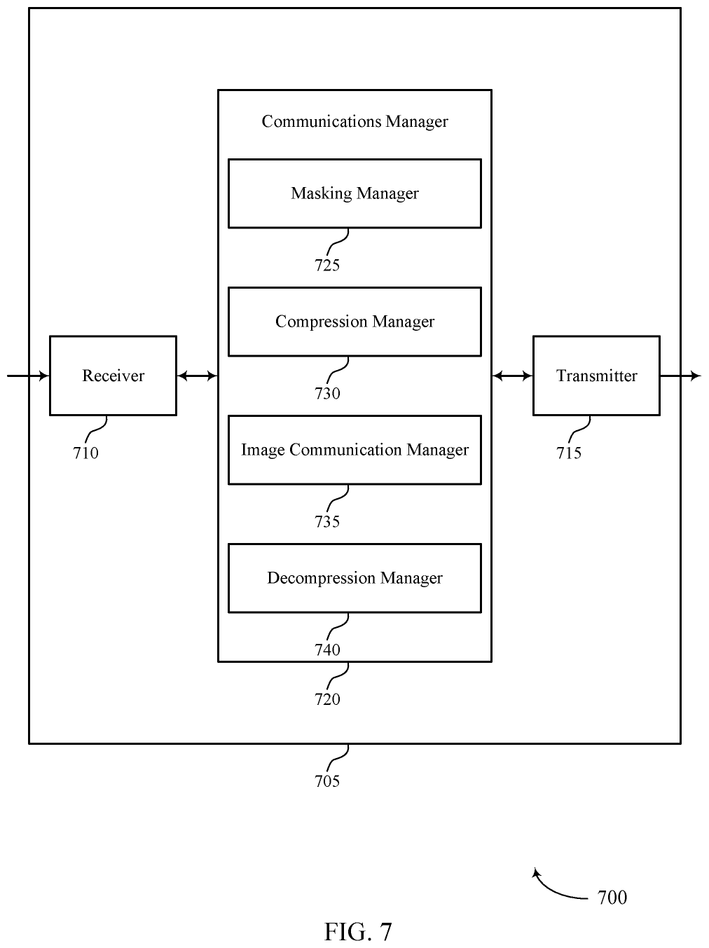

FIG. 7 shows a block diagram 700 of a device 705 that supports physical level image compression and transmission in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to physical level image compression and transmission). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to physical level image compression and transmission). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of physical level image compression and transmission as described herein. For example, the communications manager 720 may include a masking manager 725, a compression manager 730, an image communication manager 735, a decompression manager 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The masking manager 725 is capable of, configured to, or operable to support a means for transmitting an indication of one or more masking parameters associated with an inpainting scheme to a receiving device. The masking manager 725 is capable of, configured to, or operable to support a means for removing, according to the one or more masking parameters of the inpainting scheme, a portion of image data from an image to obtain a masked image, the masked image having a smaller amount of image data than the image. The compression manager 730 is capable of, configured to, or operable to support a means for compressing, according to a compression scheme, the masked image to obtain a compressed image, the compressed image having a smaller amount of image data than the masked image based on the compression. The image communication manager 735 is capable of, configured to, or operable to support a means for transmitting the compressed image to the receiving device.

Additionally, or alternatively, the communications manager 720 may support wireless communications in accordance with examples as disclosed herein. The masking manager 725 is capable of, configured to, or operable to support a means for receiving an indication of one or more masking parameters for an inpainting scheme for a UE. The image communication manager 735 is capable of, configured to, or operable to support a means for receiving a compressed image from the UE. The decompression manager 740 is capable of, configured to, or operable to support a means for decompressing, according to a compression scheme, the compressed image to obtain a masked image. The masking manager 725 is capable of, configured to, or operable to support a means for reconstructing, according to the one or more masking parameters for the inpainting scheme, an image from the masked image, the inpainting scheme generating a mask portion of the masked image that recreates the image when combined with the masked image.

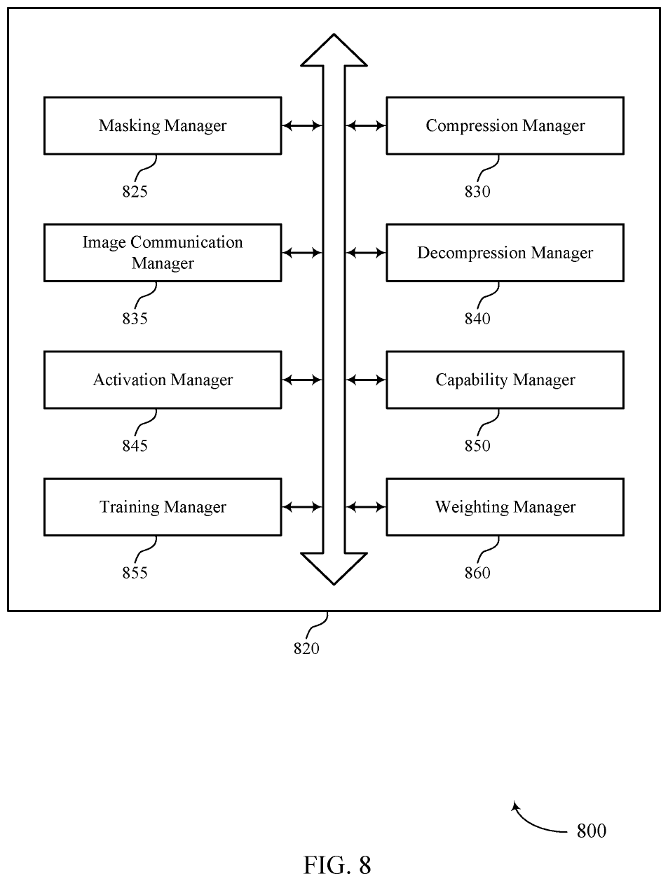

FIG. 8 shows a block diagram 800 of a communications manager 820 that supports physical level image compression and transmission in accordance with one or more aspects of the present disclosure. The communications manager 820 may be an example of aspects of a communications manager 620, a communications manager 720, or both, as described herein. The communications manager 820, or various components thereof, may be an example of means for performing various aspects of physical level image compression and transmission as described herein. For example, the communications manager 820 may include a masking manager 825, a compression manager 830, an image communication manager 835, a decompression manager 840, an activation manager 845, a capability manager 850, a training manager 855, a weighting manager 860, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The masking manager 825 is capable of, configured to, or operable to support a means for transmitting an indication of one or more masking parameters associated with an inpainting scheme to a receiving device. In some examples, the masking manager 825 is capable of, configured to, or operable to support a means for removing, according to the one or more masking parameters of the inpainting scheme, a portion of image data from an image to obtain a masked image, the masked image having a smaller amount of image data than the image. The compression manager 830 is capable of, configured to, or operable to support a means for compressing, according to a compression scheme, the masked image to obtain a compressed image, the compressed image having a smaller amount of image data than the masked image based on the compression. The image communication manager 835 is capable of, configured to, or operable to support a means for transmitting the compressed image to the receiving device.

In some examples, the activation manager 845 is capable of, configured to, or operable to support a means for transmitting an activation message initiating the inpainting scheme for the image to the receiving device, where the removing is based on the activation message.

In some examples, the activation manager 845 is capable of, configured to, or operable to support a means for receiving an activation message from the receiving device initiating the inpainting scheme for the image, where the removing is based on the activation message.

In some examples, the capability manager 850 is capable of, configured to, or operable to support a means for transmitting an image masking capability of the UE to the receiving device, where the inpainting scheme is based on the image masking capability.

In some examples, the training manager 855 is capable of, configured to, or operable to support a means for communicating with the receiving device to train the inpainting scheme to recover the image from the compressed image, the inpainting scheme based on the training.

In some examples, the training manager 855 is capable of, configured to, or operable to support a means for receiving a signal from the receiving device indicating one or more updated model parameters for the inpainting scheme, where the training is based on the one or more updated model parameters.

In some examples, the one or more updated model parameters include at least one of one or more updated model weighting factors to be applied for the inpainting scheme, a subset of layers of the inpainting scheme to be trained during the training, an updated loss function to be applied for the inpainting scheme, one or more sensors associated with the training, or a combination thereof.

In some examples, the weighting manager 860 is capable of, configured to, or operable to support a means for transmitting an updated model weighting factor to be applied for the inpainting scheme, where removing the portion of the image data is based on the updated model weighting factor.

In some examples, the weighting manager 860 is capable of, configured to, or operable to support a means for receiving an updated model weighting factor to be applied for the inpainting scheme, where removing the portion of the image data is based on the updated model weighting factor.

In some examples, the masking manager 825 is capable of, configured to, or operable to support a means for receiving a set of available inpainting schemes associated with the receiving device. In some examples, the masking manager 825 is capable of, configured to, or operable to support a means for transmitting a selected inpainting scheme from the set of available inpainting schemes to the receiving device, where the inpainting scheme includes the selected inpainting scheme.

In some examples, the masking manager 825 is capable of, configured to, or operable to support a means for transmitting a preferred inpainting scheme to be applied to the masked image to the receiving device, where the inpainting scheme is based on the preferred inpainting scheme.

In some examples, the masking manager 825 is capable of, configured to, or operable to support a means for receiving a preferred inpainting scheme to be applied to the masked image from the receiving device, where the inpainting scheme is based on the preferred inpainting scheme.

In some examples, the portion of the image data is removed from the image or from a field-of-view region of the image, the field-of-view region based on one or more sensors associated with the UE.

In some examples, the one or more masking parameters include at least one of a masking region of the image, a masking shape, a masking size, a masking location within the image, a masking periodicity, a masking index from a set of masking indices associated with the UE, or a combination thereof.

In some examples, removing the portion of image data includes at least one of removing a masked portion of the image, removing a set of masked portions from each image in a corresponding set of images, removing a frame image from a video, or a combination thereof.

In some examples, the compressed image is transmitted via a physical layer channel associated with a Uu interface, a PC5 interface, or both.

Additionally, or alternatively, the communications manager 820 may support wireless communications in accordance with examples as disclosed herein. In some examples, the masking manager 825 is capable of, configured to, or operable to support a means for receiving an indication of one or more masking parameters for an inpainting scheme for a UE. In some examples, the image communication manager 835 is capable of, configured to, or operable to support a means for receiving a compressed image from the UE. The decompression manager 840 is capable of, configured to, or operable to support a means for decompressing, according to a compression scheme, the compressed image to obtain a masked image. In some examples, the masking manager 825 is capable of, configured to, or operable to support a means for reconstructing, according to the one or more masking parameters for the inpainting scheme, an image from the masked image, the inpainting scheme generating a mask portion of the masked image that recreates the image when combined with the masked image.

In some examples, the activation manager 845 is capable of, configured to, or operable to support a means for receiving from the UE an activation message initiating the inpainting scheme for the image, where the reconstructing is based on the activation message.

In some examples, the activation manager 845 is capable of, configured to, or operable to support a means for transmitting to the UE an activation message initiating the inpainting scheme for the image, where the reconstructing is based on the activation message.

In some examples, the capability manager 850 is capable of, configured to, or operable to support a means for receiving an image masking capability of the UE, where the inpainting scheme is based on the image masking capability.

In some examples, the training manager 855 is capable of, configured to, or operable to support a means for communicating with the UE to train the inpainting scheme to reconstruct the image from the masked image, the inpainting scheme based on the training.

In some examples, the training manager 855 is capable of, configured to, or operable to support a means for transmitting a signal to the UE indicating one or more updated model parameters for the inpainting scheme, where the training is based on the one or more updated model parameters.

In some examples, the one or more updated model parameters include at least one of one or more updated model weighting factors to be applied for the inpainting scheme, a subset of layers of the inpainting scheme to be trained during the training, an updated loss function to be applied for the inpainting scheme, one or more sensors associated with the training, or a combination thereof.

In some examples, the weighting manager 860 is capable of, configured to, or operable to support a means for receiving an updated model weighting factor to be applied for the inpainting scheme, where reconstructing the image is based on the updated model weighting factor.

In some examples, the weighting manager 860 is capable of, configured to, or operable to support a means for transmitting an updated model weighting factor to be applied for the inpainting scheme, where reconstructing the image is based on the updated model weighting factor.

In some examples, the masking manager 825 is capable of, configured to, or operable to support a means for transmitting a set of available inpainting schemes associated with the receiving device to the UE. In some examples, the masking manager 825 is capable of, configured to, or operable to support a means for receiving a selected inpainting scheme from the set of available inpainting schemes to the receiving device, where the inpainting scheme includes the selected inpainting scheme.

In some examples, the masking manager 825 is capable of, configured to, or operable to support a means for receiving a preferred inpainting scheme to be applied to the masked image from the UE, where the inpainting scheme is based on the preferred inpainting scheme.

In some examples, the masking manager 825 is capable of, configured to, or operable to support a means for transmitting a preferred inpainting scheme to be applied to the masked image to the UE, where the inpainting scheme is based on the preferred inpainting scheme.

In some examples, the one or more masking parameters include at least one of a masking region of the image, a masking shape, a masking size, a masking location within the image, a masking periodicity, a masking index from a set of masking indices associated with the UE, or a combination thereof.

In some examples, reconstructing the image includes at least one of reconstructing a masked portion of the image, reconstructing a set of masked portions from each image in a corresponding set of images, reconstructing a frame image from a video, or a combination thereof.

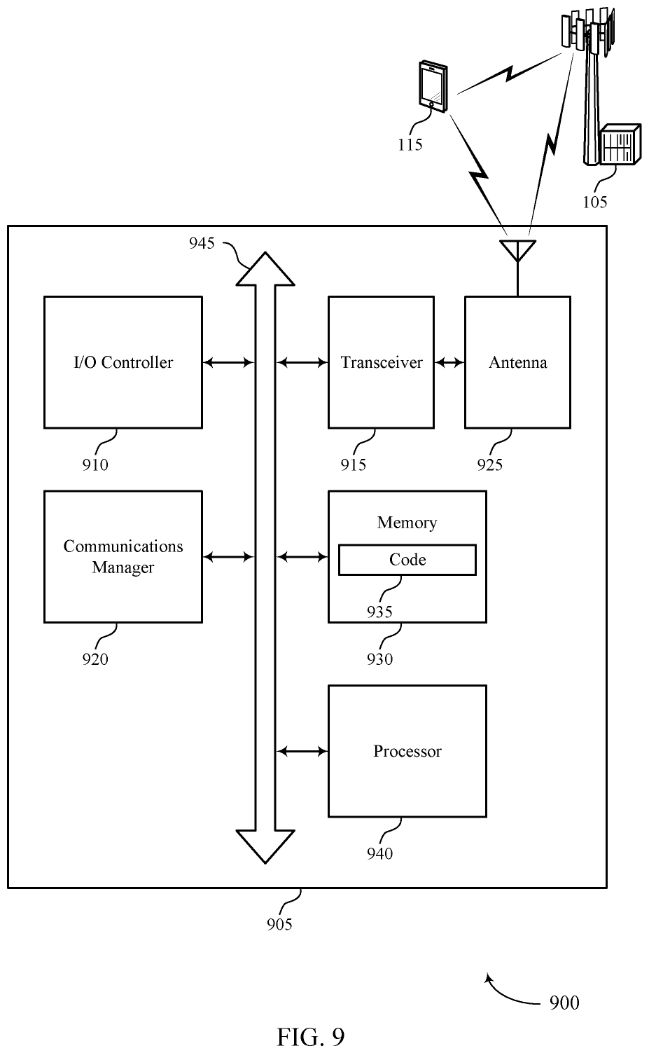

FIG. 9 shows a diagram of a system 900 including a device 905 that supports physical level image compression and transmission in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting physical level image compression and transmission). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein.

The communications manager 920 may support wireless communications in accordance with examples as disclosed herein. For example, the communications manager 920 is capable of, configured to, or operable to support a means for transmitting an indication of one or more masking parameters associated with an inpainting scheme to a receiving device. The communications manager 920 is capable of, configured to, or operable to support a means for removing, according to the one or more masking parameters of the inpainting scheme, a portion of image data from an image to obtain a masked image, the masked image having a smaller amount of image data than the image. The communications manager 920 is capable of, configured to, or operable to support a means for compressing, according to a compression scheme, the masked image to obtain a compressed image, the compressed image having a smaller amount of image data than the masked image based on the compression. The communications manager 920 is capable of, configured to, or operable to support a means for transmitting the compressed image to the receiving device.

Additionally, or alternatively, the communications manager 920 may support wireless communications in accordance with examples as disclosed herein. For example, the communications manager 920 is capable of, configured to, or operable to support a means for receiving an indication of one or more masking parameters for an inpainting scheme for a UE. The communications manager 920 is capable of, configured to, or operable to support a means for receiving a compressed image from the UE. The communications manager 920 is capable of, configured to, or operable to support a means for decompressing, according to a compression scheme, the compressed image to obtain a masked image. The communications manager 920 is capable of, configured to, or operable to support a means for reconstructing, according to the one or more masking parameters for the inpainting scheme, an image from the masked image, the inpainting scheme generating a mask portion of the masked image that recreates the image when combined with the masked image.

By including or configuring the communications manager 920 in accordance with examples as described herein, the device 905 may support techniques for providing an enhanced compression factor for image transmission by combining inpainting (removing part of the image) and compression (compressing the remaining part of the image) before transmission. The receiving device may decompress the compressed image and reconstruct the removed part using various machine learning models, such as the inpainting scheme.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of physical level image compression and transmission as described herein, or the at least one processor 940 and the at least one memory 930 may be otherwise configured to, individually or collectively, perform or support such operations.

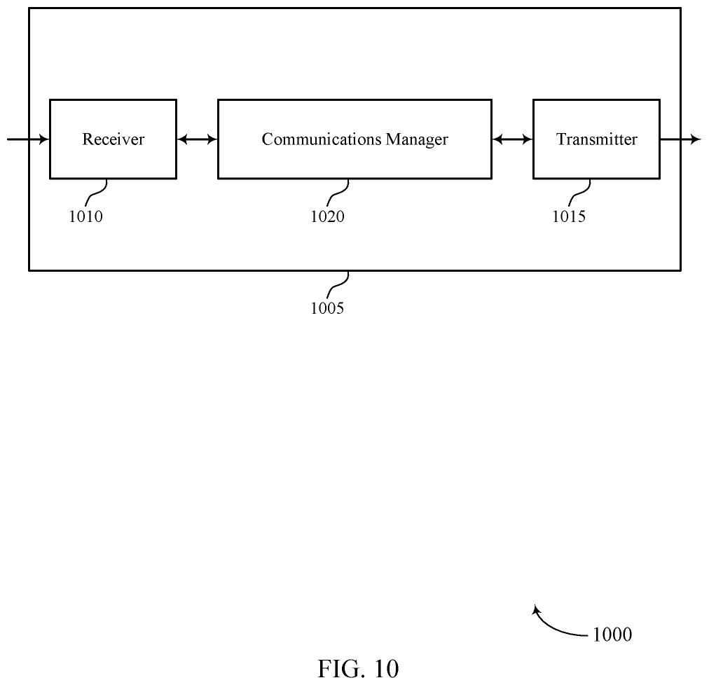

FIG. 10 shows a block diagram 1000 of a device 1005 that supports physical level image compression and transmission in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of physical level image compression and transmission as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for receiving an indication of one or more masking parameters for an inpainting scheme for a UE. The communications manager 1020 is capable of, configured to, or operable to support a means for receiving a compressed image from the UE. The communications manager 1020 is capable of, configured to, or operable to support a means for decompressing, according to a compression scheme, the compressed image to obtain a masked image. The communications manager 1020 is capable of, configured to, or operable to support a means for reconstructing, according to the one or more masking parameters for the inpainting scheme, an image from the masked image, the inpainting scheme generating a mask portion of the masked image that recreates the image when combined with the masked image.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for providing an enhanced compression factor for image transmission by combining inpainting (removing part of the image) and compression (compressing the remaining part of the image) before transmission. The receiving device may decompress the compressed image and reconstruct the removed part using various machine learning models, such as the inpainting scheme.

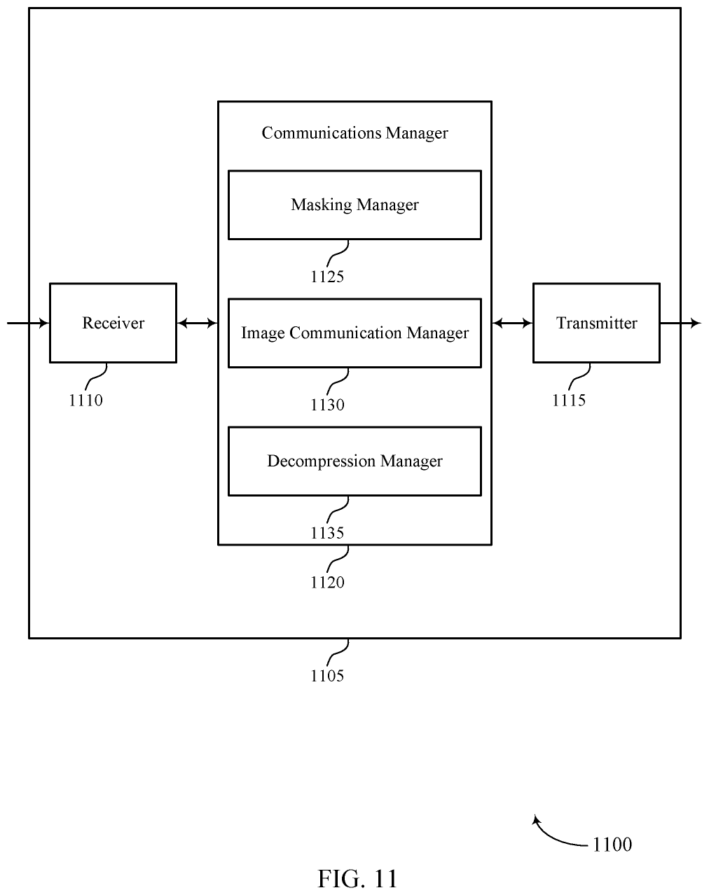

FIG. 11 shows a block diagram 1100 of a device 1105 that supports physical level image compression and transmission in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of physical level image compression and transmission as described herein. For example, the communications manager 1120 may include a masking manager 1125, an image communication manager 1130, a decompression manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The masking manager 1125 is capable of, configured to, or operable to support a means for receiving an indication of one or more masking parameters for an inpainting scheme for a UE. The image communication manager 1130 is capable of, configured to, or operable to support a means for receiving a compressed image from the UE. The decompression manager 1135 is capable of, configured to, or operable to support a means for decompressing, according to a compression scheme, the compressed image to obtain a masked image. The masking manager 1125 is capable of, configured to, or operable to support a means for reconstructing, according to the one or more masking parameters for the inpainting scheme, an image from the masked image, the inpainting scheme generating a mask portion of the masked image that recreates the image when combined with the masked image.

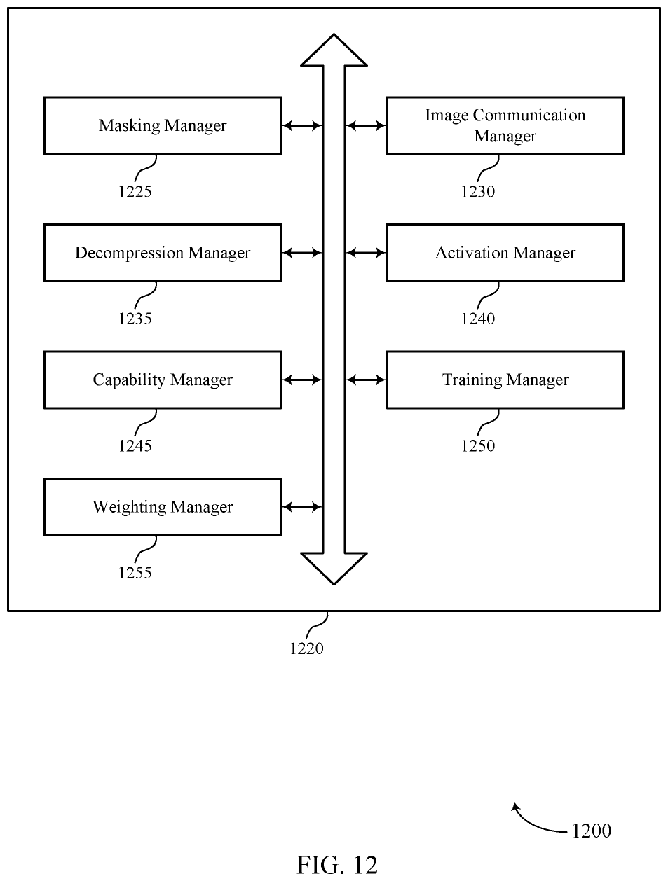

FIG. 12 shows a block diagram 1200 of a communications manager 1220 that supports physical level image compression and transmission in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of physical level image compression and transmission as described herein. For example, the communications manager 1220 may include a masking manager 1225, an image communication manager 1230, a decompression manager 1235, an activation manager 1240, a capability manager 1245, a training manager 1250, a weighting manager 1255, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The masking manager 1225 is capable of, configured to, or operable to support a means for receiving an indication of one or more masking parameters for an inpainting scheme for a UE. The image communication manager 1230 is capable of, configured to, or operable to support a means for receiving a compressed image from the UE. The decompression manager 1235 is capable of, configured to, or operable to support a means for decompressing, according to a compression scheme, the compressed image to obtain a masked image. In some examples, the masking manager 1225 is capable of, configured to, or operable to support a means for reconstructing, according to the one or more masking parameters for the inpainting scheme, an image from the masked image, the inpainting scheme generating a mask portion of the masked image that recreates the image when combined with the masked image.

In some examples, the activation manager 1240 is capable of, configured to, or operable to support a means for receiving from the UE an activation message initiating the inpainting scheme for the image, where the reconstructing is based on the activation message.

In some examples, the activation manager 1240 is capable of, configured to, or operable to support a means for transmitting to the UE an activation message initiating the inpainting scheme for the image, where the reconstructing is based on the activation message.

In some examples, the capability manager 1245 is capable of, configured to, or operable to support a means for receiving an image masking capability of the UE, where the inpainting scheme is based on the image masking capability.

In some examples, the training manager 1250 is capable of, configured to, or operable to support a means for communicating with the UE to train the inpainting scheme to reconstruct the image from the masked image, the inpainting scheme based on the training.

In some examples, the training manager 1250 is capable of, configured to, or operable to support a means for transmitting a signal to the UE indicating one or more updated model parameters for the inpainting scheme, where the training is based on the one or more updated model parameters.

In some examples, the one or more updated model parameters include at least one of one or more updated model weighting factors to be applied for the inpainting scheme, a subset of layers of the inpainting scheme to be trained during the training, an updated loss function to be applied for the inpainting scheme, one or more sensors associated with the training, or a combination thereof.

In some examples, the weighting manager 1255 is capable of, configured to, or operable to support a means for receiving an updated model weighting factor to be applied for the inpainting scheme, where reconstructing the image is based on the updated model weighting factor.

In some examples, the weighting manager 1255 is capable of, configured to, or operable to support a means for transmitting an updated model weighting factor to be applied for the inpainting scheme, where reconstructing the image is based on the updated model weighting factor.

In some examples, the masking manager 1225 is capable of, configured to, or operable to support a means for transmitting a set of available inpainting schemes associated with the receiving device to the UE. In some examples, the masking manager 1225 is capable of, configured to, or operable to support a means for receiving a selected inpainting scheme from the set of available inpainting schemes to the receiving device, where the inpainting scheme includes the selected inpainting scheme.

In some examples, the masking manager 1225 is capable of, configured to, or operable to support a means for receiving a preferred inpainting scheme to be applied to the masked image from the UE, where the inpainting scheme is based on the preferred inpainting scheme.

In some examples, the masking manager 1225 is capable of, configured to, or operable to support a means for transmitting a preferred inpainting scheme to be applied to the masked image to the UE, where the inpainting scheme is based on the preferred inpainting scheme.

In some examples, the one or more masking parameters include at least one of a masking region of the image, a masking shape, a masking size, a masking location within the image, a masking periodicity, a masking index from a set of masking indices associated with the UE, or a combination thereof.

In some examples, reconstructing the image includes at least one of reconstructing a masked portion of the image, reconstructing a set of masked portions from each image in a corresponding set of images, reconstructing a frame image from a video, or a combination thereof.

In some examples, the compressed image is received via a physical layer channel associated with a Uu interface, a PC5 interface, or both.

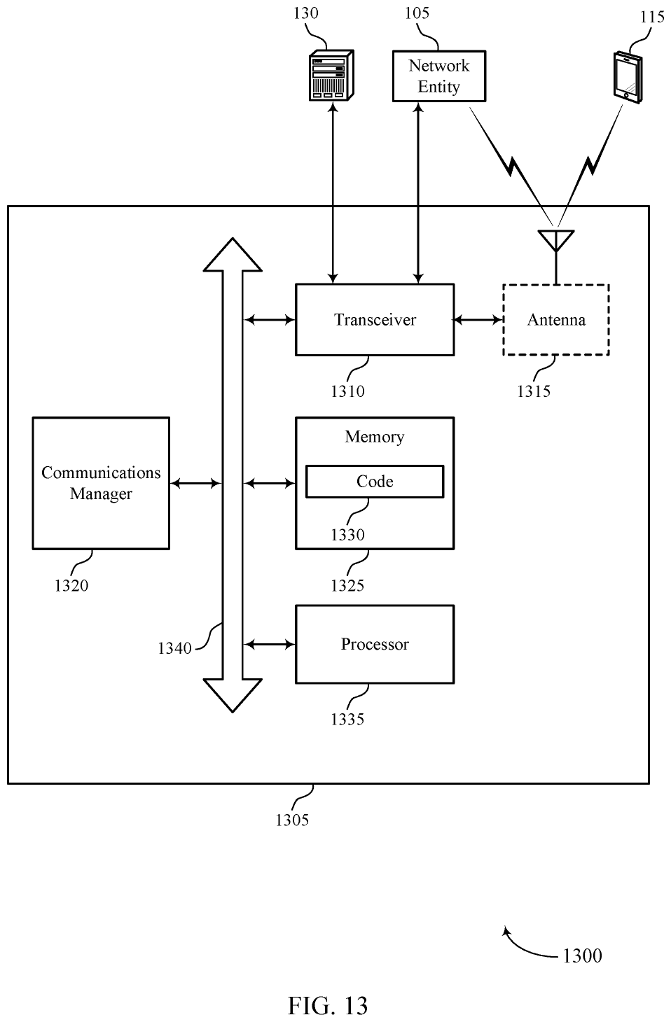

FIG. 13 shows a diagram of a system 1300 including a device 1305 that supports physical level image compression and transmission in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting physical level image compression and transmission). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some implementations, the at least one processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the at least one processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105 and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for receiving an indication of one or more masking parameters for an inpainting scheme for a UE. The communications manager 1320 is capable of, configured to, or operable to support a means for receiving a compressed image from the UE. The communications manager 1320 is capable of, configured to, or operable to support a means for decompressing, according to a compression scheme, the compressed image to obtain a masked image. The communications manager 1320 is capable of, configured to, or operable to support a means for reconstructing, according to the one or more masking parameters for the inpainting scheme, an image from the masked image, the inpainting scheme generating a mask portion of the masked image that recreates the image when combined with the masked image.

By including or configuring the communications manager 1320 in accordance with examples as described herein, the device 1305 may support techniques for providing an enhanced compression factor for image transmission by combining inpainting (removing part of the image) and compression (compressing the remaining part of the image) before transmission. The receiving device may decompress the compressed image and reconstruct the removed part using various machine learning models, such as the inpainting scheme.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of physical level image compression and transmission as described herein, or the at least one processor 1335 and the at least one memory 1325 may be otherwise configured to, individually or collectively, perform or support such operations.

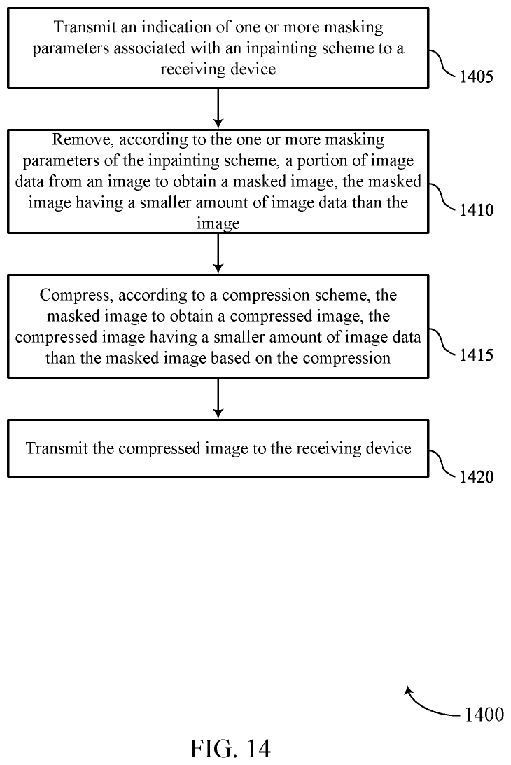

FIG. 14 shows a flowchart illustrating a method 1400 that supports physical level image compression and transmission in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting an indication of one or more masking parameters associated with an inpainting scheme to a receiving device. The operations of block 1405 may be performed in accordance with examples as disclosed herein. In some examples, aspects of the operations of 1405 may be performed by a masking manager 825 as described with reference to FIG. 8.

At 1410, the method may include removing, according to the one or more masking parameters of the inpainting scheme, a portion of image data from an image to obtain a masked image, the masked image having a smaller amount of image data than the image. The operations of block 1410 may be performed in accordance with examples as disclosed herein. In some examples, aspects of the operations of 1410 may be performed by a masking manager 825 as described with reference to FIG. 8.

At 1415, the method may include compressing, according to a compression scheme, the masked image to obtain a compressed image, the compressed image having a smaller amount of image data than the masked image based on the compression. The operations of block 1415 may be performed in accordance with examples as disclosed herein. In some examples, aspects of the operations of 1415 may be performed by a compression manager 830 as described with reference to FIG. 8.

At 1420, the method may include transmitting the compressed image to the receiving device. The operations of block 1420 may be performed in accordance with examples as disclosed herein. In some examples, aspects of the operations of 1420 may be performed by an image communication manager 835 as described with reference to FIG. 8.

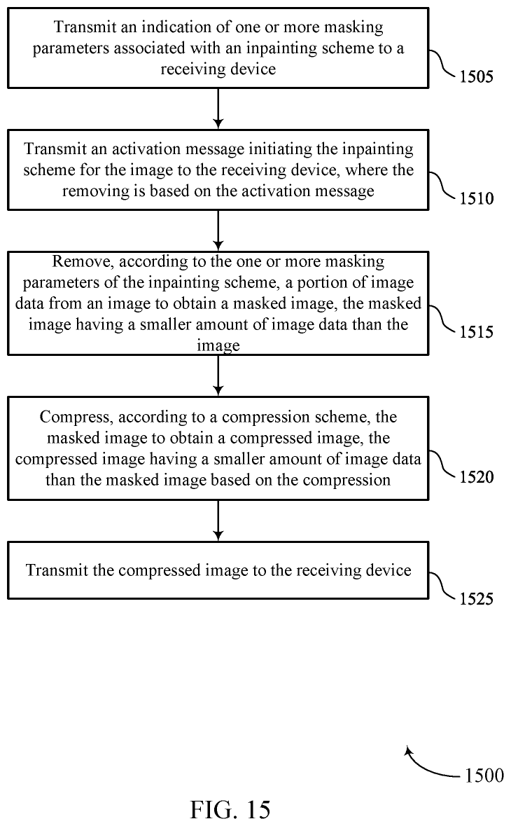

FIG. 15 shows a flowchart illustrating a method 1500 that supports physical level image compression and transmission in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting an indication of one or more masking parameters associated with an inpainting scheme to a receiving device. The operations of block 1505 may be performed in accordance with examples as disclosed herein. In some examples, aspects of the operations of 1505 may be performed by a masking manager 825 as described with reference to FIG. 8.

At 1510, the method may include transmitting an activation message initiating the inpainting scheme for the image to the receiving device, where the removing is based on the activation message. The operations of block 1510 may be performed in accordance with examples as disclosed herein. In some examples, aspects of the operations of 1510 may be performed by an activation manager 845 as described with reference to FIG. 8.

At 1515, the method may include removing, according to the one or more masking parameters of the inpainting scheme, a portion of image data from an image to obtain a masked image, the masked image having a smaller amount of image data than the image. The operations of block 1515 may be performed in accordance with examples as disclosed herein. In some examples, aspects of the operations of 1515 may be performed by a masking manager 825 as described with reference to FIG. 8.

At 1520, the method may include compressing, according to a compression scheme, the masked image to obtain a compressed image, the compressed image having a smaller amount of image data than the masked image based on the compression. The operations of block 1520 may be performed in accordance with examples as disclosed herein. In some examples, aspects of the operations of 1520 may be performed by a compression manager 830 as described with reference to FIG. 8.

At 1525, the method may include transmitting the compressed image to the receiving device. The operations of block 1525 may be performed in accordance with examples as disclosed herein. In some examples, aspects of the operations of 1525 may be performed by an image communication manager 835 as described with reference to FIG. 8.

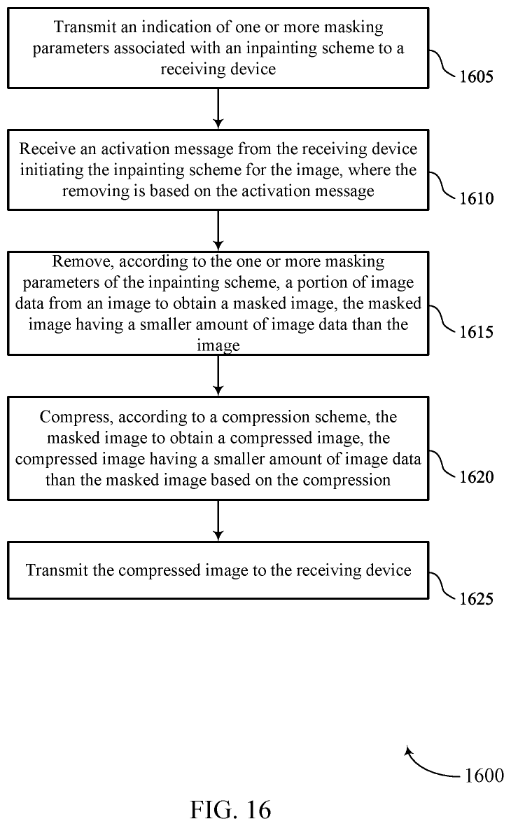

FIG. 16 shows a flowchart illustrating a method 1600 that supports physical level image compression and transmission in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include transmitting an indication of one or more masking parameters associated with an inpainting scheme to a receiving device. The operations of block 1605 may be performed in accordance with examples as disclosed herein. In some examples, aspects of the operations of 1605 may be performed by a masking manager 825 as described with reference to FIG. 8.

At 1610, the method may include receiving an activation message from the receiving device initiating the inpainting scheme for the image, where the removing is based on the activation message. The operations of block 1610 may be performed in accordance with examples as disclosed herein. In some examples, aspects of the operations of 1610 may be performed by an activation manager 845 as described with reference to FIG. 8.

At 1615, the method may include removing, according to the one or more masking parameters of the inpainting scheme, a portion of image data from an image to obtain a masked image, the masked image having a smaller amount of image data than the image. The operations of block 1615 may be performed in accordance with examples as disclosed herein. In some examples, aspects of the operations of 1615 may be performed by a masking manager 825 as described with reference to FIG. 8.

At 1620, the method may include compressing, according to a compression scheme, the masked image to obtain a compressed image, the compressed image having a smaller amount of image data than the masked image based on the compression. The operations of block 1620 may be performed in accordance with examples as disclosed herein. In some examples, aspects of the operations of 1620 may be performed by a compression manager 830 as described with reference to FIG. 8.

At 1625, the method may include transmitting the compressed image to the receiving device. The operations of block 1625 may be performed in accordance with examples as disclosed herein. In some examples, aspects of the operations of 1625 may be performed by an image communication manager 835 as described with reference to FIG. 8.

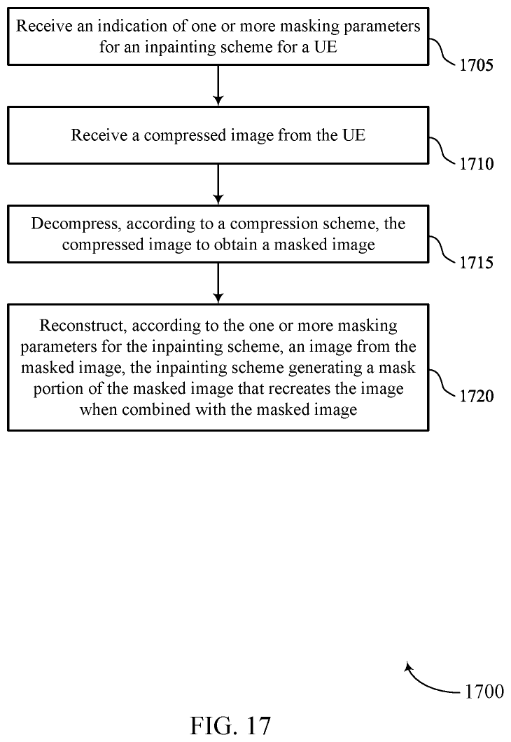

FIG. 17 shows a flowchart illustrating a method 1700 that supports physical level image compression and transmission in accordance with aspects of the present disclosure. The operations of the method 1700 may be implemented by a UE or a network entity or its components as described herein. For example, the operations of the method 1700 may be performed by a UE 115 as described with reference to FIGS. 1 through 9 or a network entity as described with reference to FIGS. 1 through 5 and 10 through 13. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1705, the method may include receiving an indication of one or more masking parameters for an inpainting scheme for a UE. The operations of block 1705 may be performed in accordance with examples as disclosed herein. In some examples, aspects of the operations of 1705 may be performed by a masking manager 825 or a masking manager 1225 as described with reference to FIGS. 8 and 12.

At 1710, the method may include receiving a compressed image from the UE. The operations of block 1710 may be performed in accordance with examples as disclosed herein. In some examples, aspects of the operations of 1710 may be performed by an image communication manager 835 or an image communication manager 1230 as described with reference to FIGS. 8 and 12.

At 1715, the method may include decompressing, according to a compression scheme, the compressed image to obtain a masked image. The operations of block 1715 may be performed in accordance with examples as disclosed herein. In some examples, aspects of the operations of 1715 may be performed by a decompression manager 840 or a decompression manager 1235 as described with reference to FIGS. 8 and 12.

At 1720, the method may include reconstructing, according to the one or more masking parameters for the inpainting scheme, an image from the masked image, the inpainting scheme generating a mask portion of the masked image that recreates the image when combined with the masked image. The operations of block 1720 may be performed in accordance with examples as disclosed herein. In some examples, aspects of the operations of 1720 may be performed by a masking manager 825 or a masking manager 1225 as described with reference to FIGS. 8 and 12.

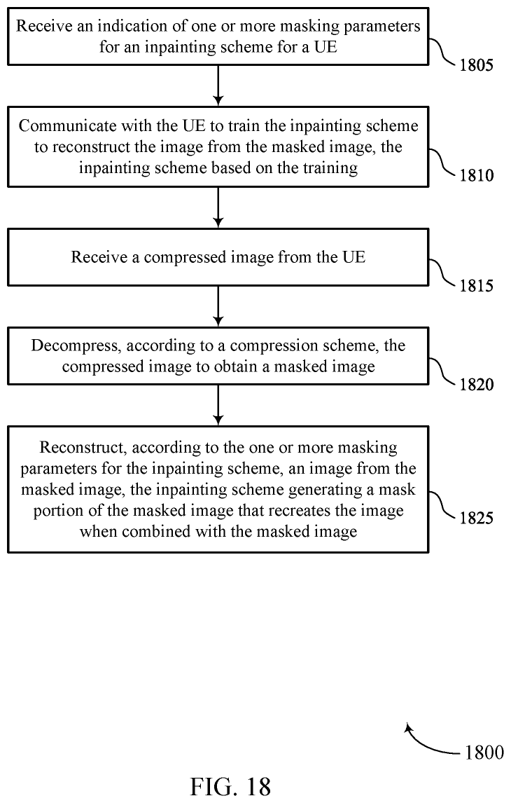

FIG. 18 shows a flowchart illustrating a method 1800 that supports physical level image compression and transmission in accordance with aspects of the present disclosure. The operations of the method 1800 may be implemented by a UE or a network entity or its components as described herein. For example, the operations of the method 1800 may be performed by a UE 115 as described with reference to FIGS. 1 through 9 or a network entity as described with reference to FIGS. 1 through 5 and 10 through 13. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1805, the method may include receiving an indication of one or more masking parameters for an inpainting scheme for a UE. The operations of block 1805 may be performed in accordance with examples as disclosed herein. In some examples, aspects of the operations of 1805 may be performed by a masking manager 825 or a masking manager 1225 as described with reference to FIGS. 8 and 12.

At 1810, the method may include communicating with the UE to train the inpainting scheme to reconstruct the image from the masked image, the inpainting scheme based on the training. The operations of block 1810 may be performed in accordance with examples as disclosed herein. In some examples, aspects of the operations of 1810 may be performed by a training manager 855 or a training manager 1250 as described with reference to FIGS. 8 and 12.

At 1815, the method may include receiving a compressed image from the UE. The operations of block 1815 may be performed in accordance with examples as disclosed herein. In some examples, aspects of the operations of 1815 may be performed by an image communication manager 835 or an image communication manager 1230 as described with reference to FIGS. 8 and 12.

At 1820, the method may include decompressing, according to a compression scheme, the compressed image to obtain a masked image. The operations of block 1820 may be performed in accordance with examples as disclosed herein. In some examples, aspects of the operations of 1820 may be performed by a decompression manager 840 or a decompression manager 1235 as described with reference to FIGS. 8 and 12.

At 1825, the method may include reconstructing, according to the one or more masking parameters for the inpainting scheme, an image from the masked image, the inpainting scheme generating a mask portion of the masked image that recreates the image when combined with the masked image. The operations of block 1825 may be performed in accordance with examples as disclosed herein. In some examples, aspects of the operations of 1825 may be performed by a masking manager 825 or a masking manager 1225 as described with reference to FIGS. 8 and 12.

The following provides an overview of aspects of the present disclosure:

Aspect 1: A method for wireless communications by a UE, comprising: transmitting an indication of one or more masking parameters associated with an inpainting scheme to a receiving device; removing, according to the one or more masking parameters of the inpainting scheme, a portion of image data from an image to obtain a masked image, the masked image having a smaller amount of image data than the image; compressing, according to a compression scheme, the masked image to obtain a compressed image, the compressed image having a smaller amount of image data than the masked image based at least in part on the compression; and transmitting the compressed image to the receiving device.

Aspect 2: The method of aspect 1, further comprising: transmitting an activation message initiating the inpainting scheme for the image to the receiving device, wherein the removing is based at least in part on the activation message.

Aspect 3: The method of any of aspects 1 through 2, further comprising: receiving an activation message from the receiving device initiating the inpainting scheme for the image, wherein the removing is based at least in part on the activation message.

Aspect 4: The method of any of aspects 1 through 3, further comprising: transmitting an image masking capability of the UE to the receiving device, wherein the inpainting scheme is based at least in part on the image masking capability.

Aspect 5: The method of any of aspects 1 through 4, further comprising: communicating with the receiving device to train the inpainting scheme to recover the image from the compressed image, the inpainting scheme based at least in part on the training.

Aspect 6: The method of aspect 5, further comprising: receiving a signal from the receiving device indicating one or more updated model parameters for the inpainting scheme, wherein the training is based at least in part on the one or more updated model parameters.

Aspect 7: The method of aspect 6, wherein the one or more updated model parameters comprise at least one of one or more updated model weighting factors to be applied for the inpainting scheme, a subset of layers of the inpainting scheme to be trained during the training, an updated loss function to be applied for the inpainting scheme, one or more sensors associated with the training, or a combination thereof.

Aspect 8: The method of any of aspects 1 through 7, further comprising: transmitting an updated model weighting factor to be applied for the inpainting scheme, wherein removing the portion of the image data is based at least in part on the updated model weighting factor.

Aspect 9: The method of any of aspects 1 through 8, further comprising: receiving an updated model weighting factor to be applied for the inpainting scheme, wherein removing the portion of the image data is based at least in part on the updated model weighting factor.

Aspect 10: The method of any of aspects 1 through 9, further comprising: receiving a set of available inpainting schemes associated with the receiving device; and transmitting a selected inpainting scheme from the set of available inpainting schemes to the receiving device, wherein the inpainting scheme comprises the selected inpainting scheme.

Aspect 11: The method of any of aspects 1 through 10, further comprising: transmitting a preferred inpainting scheme to be applied to the masked image to the receiving device, wherein the inpainting scheme is based at least in part on the preferred inpainting scheme.

Aspect 12: The method of any of aspects 1 through 11, further comprising: receiving a preferred inpainting scheme to be applied to the masked image from the receiving device, wherein the inpainting scheme is based at least in part on the preferred inpainting scheme.

Aspect 13: The method of any of aspects 1 through 12, wherein the portion of the image data is removed from the image or from a field-of-view region of the image, the field-of-view region based on one or more sensors associated with the UE.

Aspect 14: The method of any of aspects 1 through 13, wherein the one or more masking parameters comprise at least one of a masking region of the image, a masking shape, a masking size, a masking location within the image, a masking periodicity, a masking index from a set of masking indices associated with the UE, or a combination thereof.

Aspect 15: The method of any of aspects 1 through 14, wherein removing the portion of image data comprises at least one of removing a masked portion of the image, removing a set of masked portions from each image in a corresponding set of images, removing a frame image from a video, or a combination thereof.

Aspect 16: A method for wireless communications by a receiving device, comprising: receiving an indication of one or more masking parameters for an inpainting scheme for a UE; receiving a compressed image from the UE; decompressing, according to a compression scheme, the compressed image to obtain a masked image; and reconstructing, according to the one or more masking parameters for the inpainting scheme, an image from the masked image, the inpainting scheme generating a mask portion of the masked image that recreates the image when combined with the masked image.

Aspect 17: The method of aspect 16, further comprising: receiving from the UE an activation message initiating the inpainting scheme for the image, wherein the reconstructing is based at least in part on the activation message.

Aspect 18: The method of any of aspects 16 through 17, further comprising: transmitting to the UE an activation message initiating the inpainting scheme for the image, wherein the reconstructing is based at least in part on the activation message.

Aspect 19: The method of any of aspects 16 through 18, further comprising: receiving an image masking capability of the UE, wherein the inpainting scheme is based at least in part on the image masking capability.

Aspect 20: The method of any of aspects 16 through 19, further comprising: communicating with the UE to train the inpainting scheme to reconstruct the image from the masked image, the inpainting scheme based at least in part on the training.

Aspect 21: The method of aspect 20, further comprising: transmitting a signal to the UE indicating one or more updated model parameters for the inpainting scheme, wherein the training is based at least in part on the one or more updated model parameters.

Aspect 22: The method of aspect 21, wherein the one or more updated model parameters comprise at least one of one or more updated model weighting factors to be applied for the inpainting scheme, a subset of layers of the inpainting scheme to be trained during the training, an updated loss function to be applied for the inpainting scheme, one or more sensors associated with the training, or a combination thereof.

Aspect 23: The method of any of aspects 16 through 22, further comprising: receiving an updated model weighting factor to be applied for the inpainting scheme, wherein reconstructing the image is based at least in part on the updated model weighting factor.

Aspect 24: The method of any of aspects 16 through 23, further comprising: transmitting an updated model weighting factor to be applied for the inpainting scheme, wherein reconstructing the image is based at least in part on the updated model weighting factor.

Aspect 25: The method of any of aspects 16 through 24, further comprising: transmitting a set of available inpainting schemes associated with the receiving device to the UE; and receiving a selected inpainting scheme from the set of available inpainting schemes to the receiving device, wherein the inpainting scheme comprises the selected inpainting scheme.

Aspect 26: The method of any of aspects 16 through 25, further comprising: receiving a preferred inpainting scheme to be applied to the masked image from the UE, wherein the inpainting scheme is based at least in part on the preferred inpainting scheme.

Aspect 27: The method of any of aspects 16 through 26, further comprising: transmitting a preferred inpainting scheme to be applied to the masked image to the UE, wherein the inpainting scheme is based at least in part on the preferred inpainting scheme.

Aspect 28: The method of any of aspects 16 through 27, wherein the one or more masking parameters comprise at least one of a masking region of the image, a masking shape, a masking size, a masking location within the image, a masking periodicity, a masking index from a set of masking indices associated with the UE, or a combination thereof.

Aspect 29: The method of any of aspects 16 through 28, wherein reconstructing the image comprises at least one of reconstructing a masked portion of the image, reconstructing a set of masked portions from each image in a corresponding set of images, reconstructing a frame image from a video, or a combination thereof.

Aspect 30: A UE for wireless communications, comprising one or more memories storing processor-executable code, and one or more processors coupled with the one or more memories and individually or collectively operable to execute the code to cause the UE to perform a method of any of aspects 1 through 15.

Aspect 31: A UE for wireless communications, comprising at least one means for performing a method of any of aspects 1 through 15.

Aspect 32: A non-transitory computer-readable medium storing code for wireless communications, the code comprising instructions executable by a processor to perform a method of any of aspects 1 through 15.

Aspect 33: A receiving device for wireless communications, comprising one or more memories storing processor-executable code, and one or more processors coupled with the one or more memories and individually or collectively operable to execute the code to cause the receiving device to perform a method of any of aspects 16 through 29.

Aspect 34: A receiving device for wireless communications, comprising at least one means for performing a method of any of aspects 16 through 29.

Aspect 35: A non-transitory computer-readable medium storing code for wireless communications, the code comprising instructions executable by a processor to perform a method of any of aspects 16 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions. The term “a set” shall be construed in the same manner as “one or more.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communications, comprising:
one or more memories storing processor-executable code; and
one or more processors coupled with the one or more memories and individually or collectively operable to execute the code to cause the UE to:
transmit an indication of one or more masking parameters associated with an inpainting scheme to a receiving device;
remove, according to the one or more masking parameters of the inpainting scheme, a portion of image data from an image to obtain a masked image, the masked image having a smaller amount of image data than the image;
compress, according to a compression scheme, the masked image to obtain a compressed image, the compressed image having a smaller amount of image data than the masked image based at least in part on the compression; and
transmit the compressed image to the receiving device.

2. The UE of claim 1, wherein the one or more processors are individually or collectively further operable to execute the code to cause the UE to:
transmit an activation message initiating the inpainting scheme for the image to the receiving device, wherein the removing is based at least in part on the activation message.

3. The UE of claim 1, wherein the one or more processors are individually or collectively further operable to execute the code to cause the UE to:
receive an activation message from the receiving device initiating the inpainting scheme for the image, wherein the removing is based at least in part on the activation message.

4. The UE of claim 1, wherein the one or more processors are individually or collectively further operable to execute the code to cause the UE to:
transmit an image masking capability of the UE to the receiving device, wherein the inpainting scheme is based at least in part on the image masking capability.

5. The UE of claim 1, wherein the one or more processors are individually or collectively further operable to execute the code to cause the UE to:
communicate with the receiving device to train the inpainting scheme to recover the image from the compressed image, the inpainting scheme based at least in part on the training.

6. The UE of claim 5, wherein the one or more processors are individually or collectively further operable to execute the code to cause the UE to:
receive a signal from the receiving device indicating one or more updated model parameters for the inpainting scheme, wherein the training is based at least in part on the one or more updated model parameters.

7. The UE of claim 6, wherein the one or more updated model parameters comprise at least one of one or more updated model weighting factors to be applied for the inpainting scheme, a subset of layers of the inpainting scheme to be trained during the training, an updated loss function to be applied for the inpainting scheme, one or more sensors associated with the training, or a combination thereof.

8. The UE of claim 1, wherein the one or more processors are individually or collectively further operable to execute the code to cause the UE to:
transmit an updated model weighting factor to be applied for the inpainting scheme, wherein removing the portion of the image data is based at least in part on the updated model weighting factor.

9. The UE of claim 1, wherein the one or more processors are individually or collectively further operable to execute the code to cause the UE to:
receive an updated model weighting factor to be applied for the inpainting scheme, wherein removing the portion of the image data is based at least in part on the updated model weighting factor.

10. The UE of claim 1, wherein the one or more processors are individually or collectively further operable to execute the code to cause the UE to:
receive a set of available inpainting schemes associated with the receiving device; and
transmit a selected inpainting scheme from the set of available inpainting schemes to the receiving device, wherein the inpainting scheme comprises the selected inpainting scheme.

11. The UE of claim 1, wherein the one or more processors are individually or collectively further operable to execute the code to cause the UE to:
transmit a preferred inpainting scheme to be applied to the masked image to the receiving device, wherein the inpainting scheme is based at least in part on the preferred inpainting scheme.

12. The UE of claim 1, wherein the one or more processors are individually or collectively further operable to execute the code to cause the UE to:
receive a preferred inpainting scheme to be applied to the masked image from the receiving device, wherein the inpainting scheme is based at least in part on the preferred inpainting scheme.

13. The UE of claim 1, wherein the portion of the image data is removed from the image or from a field-of-view region of the image, the field-of-view region based on one or more sensors associated with the UE.

14. The UE of claim 1, wherein the one or more masking parameters comprise at least one of a masking region of the image, a masking shape, a masking size, a masking location within the image, a masking periodicity, a masking index from a set of masking indices associated with the UE, or a combination thereof.

15. The UE of claim 1, wherein removing the portion of image data comprises at least one of removing a masked portion of the image, removing a set of masked portions from each image in a corresponding set of images, removing a frame image from a video, or a combination thereof.

16. The UE of claim 1, wherein the compressed image is transmitted via a physical layer channel associated with a Uu interface, a PC5 interface, or both.

17. A receiving device, comprising:
one or more memories storing processor-executable code; and
one or more processors coupled with the one or more memories and individually or collectively operable to execute the code to cause the receiving device to:
receive an indication of one or more masking parameters for an inpainting scheme for a user equipment (UE);
receive a compressed image from the UE;
decompress, according to a compression scheme, the compressed image to obtain a masked image; and
reconstruct, according to the one or more masking parameters for the inpainting scheme, an image from the masked image, the inpainting scheme generating a mask portion of the masked image that recreates the image when combined with the masked image.

18. The receiving device of claim 17, wherein the one or more processors are individually or collectively further operable to execute the code to cause the receiving device to:
receive from the UE an activation message initiating the inpainting scheme for the image, wherein the reconstructing is based at least in part on the activation message.

19. The receiving device of claim 17, wherein the one or more processors are individually or collectively further operable to execute the code to cause the receiving device to:
transmit to the UE an activation message initiating the inpainting scheme for the image, wherein the reconstructing is based at least in part on the activation message.

20. The receiving device of claim 17, wherein the one or more processors are individually or collectively further operable to execute the code to cause the receiving device to:
receive an image masking capability of the UE, wherein the inpainting scheme is based at least in part on the image masking capability.

21. The receiving device of claim 17, wherein the one or more processors are individually or collectively further operable to execute the code to cause the receiving device to:
communicate with the UE to train the inpainting scheme to reconstruct the image from the masked image, the inpainting scheme based at least in part on the training.

22. The receiving device of claim 21, wherein the one or more processors are individually or collectively further operable to execute the code to cause the receiving device to:
transmit a signal to the UE indicating one or more updated model parameters for the inpainting scheme, wherein the training is based at least in part on the one or more updated model parameters.

23. The receiving device of claim 22, wherein the one or more updated model parameters comprise at least one of one or more updated model weighting factors to be applied for the inpainting scheme, a subset of layers of the inpainting scheme to be trained during the training, an updated loss function to be applied for the inpainting scheme, one or more sensors associated with the training, or a combination thereof.

24. The receiving device of claim 17, wherein the one or more processors are individually or collectively further operable to execute the code to cause the receiving device to:
receive an updated model weighting factor to be applied for the inpainting scheme, wherein reconstructing the image is based at least in part on the updated model weighting factor.

25. The receiving device of claim 17, wherein the one or more processors are individually or collectively further operable to execute the code to cause the receiving device to:
transmit an updated model weighting factor to be applied for the inpainting scheme, wherein reconstructing the image is based at least in part on the updated model weighting factor.

26. The receiving device of claim 17, wherein the one or more processors are individually or collectively further operable to execute the code to cause the receiving device to:
transmit a set of available inpainting schemes associated with the receiving device to the UE; and
receive a selected inpainting scheme from the set of available inpainting schemes to the receiving device, wherein the inpainting scheme comprises the selected inpainting scheme.

27. The receiving device of claim 17, wherein the one or more processors are individually or collectively further operable to execute the code to cause the receiving device to:
receive a preferred inpainting scheme to be applied to the masked image from the UE, wherein the inpainting scheme is based at least in part on the preferred inpainting scheme.

28. The receiving device of claim 17, wherein the one or more processors are individually or collectively further operable to execute the code to cause the receiving device to:
transmit a preferred inpainting scheme to be applied to the masked image to the UE, wherein the inpainting scheme is based at least in part on the preferred inpainting scheme.

29. A method for wireless communications by a user equipment (UE), comprising:
transmitting an indication of one or more masking parameters associated with an inpainting scheme to a receiving device;
removing, according to the one or more masking parameters of the inpainting scheme, a portion of image data from an image to obtain a masked image, the masked image having a smaller amount of image data than the image;
compressing, according to a compression scheme, the masked image to obtain a compressed image, the compressed image having a smaller amount of image data than the masked image based at least in part on the compression; and
transmitting the compressed image to the receiving device.

30. A method for wireless communications by a receiving device, comprising:
receiving an indication of one or more masking parameters for an inpainting scheme for a user equipment (UE);
receiving a compressed image from the UE;
decompressing, according to a compression scheme, the compressed image to obtain a masked image; and
reconstructing, according to the one or more masking parameters for the inpainting scheme, an image from the masked image, the inpainting scheme generating a mask portion of the masked image that recreates the image when combined with the masked image.
